(19) United States
(12) Patent Application Publication
(10) Pub. No.: US 2026/0359702 A1
(43) Pub. Date: Nov. 12, 2026

(54) FAULT-TOLERANT PREPARATION OF CSS LOGICAL QUBITS

(71) Applicant: Quantinuum LTD, London (GB)

(72) Inventors: David AMARO, London (GB); Diego FORLIVESI, London (GB)

(21) Appl. No.: 19/669,412

(22) Filed: May 6, 2026

Related U.S. Application Data
(60) Provisional application No. 63/800,670, filed on May 6, 2025.

(51) Int. Cl. G06N 10/70

(52) U.S. Cl. CPC G06N 10/70

(57) ABSTRACT

In various embodiments, a logical qubit of a QEC code is prepared in a fault-tolerant mode. For example, the controller of a quantum computer causes, in accordance with an encoding circuit, performance of a plurality of entangling gates on respective pairs of a plurality of data qubit. Each entangling gate of the plurality of entangling gates is controlled by a control data qubit and targets a target data qubit. The control data qubit is a member of a control group comprising at least one data qubit of the plurality of data qubits and the target data qubit is a member of a target group comprising one or more data qubits of the plurality of data qubits. The control group and the target group are non-overlapping.

### CROSS-REFERENCE TO RELATED APPLICATION(S)

This application claims priority to U.S. Application No. 63/800,670, filed May 6, 2025, the content of which is incorporated by reference herein in its entirety.

### TECHNICAL FIELD

The present disclosure relates to the fault-tolerant preparation of Calderbank, Shor, and Steane (CSS) logical qubits.

### BACKGROUND

Quantum error correction (QEC) and fault-tolerant quantum computing use logical qubits to perform quantum computing functions in a manner that is fault-tolerant. A logical qubit comprises a plurality of physical qubits that are entangled in manner specific to the particular QEC code being used. Conventional methods for preparing the logical qubits in a fault-tolerant manner tend to be computationally intensive for a quantum processor to perform (e.g., they are not optimized) and may require many iterations to fault-tolerantly prepare the logical qubit. Through applied effort, ingenuity, and innovation many deficiencies of preparing CSS logical qubits have been solved by developing solutions that are structured in accordance with the embodiments of the present invention, many examples of which are described in detail herein.

### BRIEF SUMMARY OF EXAMPLE EMBODIMENTS

Various embodiments provide methods, systems, apparatus, computer program products, and/or the like for efficient preparation of CSS logical qubits. For example, in various embodiments, a logical qubit includes a plurality of data qubits that are entangled in accordance with a particular QEC code. In various embodiments, the data qubits are physical qubits of the quantum computer/processor. The plurality of data qubits of a logical qubit are divided into a control group and a target group. During the logical qubit preparation, the qubits of the control group are used as the control qubits in performing CNOT gates on respective qubits of the target group. In other words, the logical qubit is prepared as a bipartite graph state. For example, the encoding circuit for preparing the logical qubit includes a plurality of CNOT gates that each include a respective control qubit from the control group of data qubits and a respective target qubit from the target group of data qubits. This provides for improved efficiency of the preparation of the logical qubit.

As a result of the structure of the encoding circuit, the only errors that may be propagated from qubits of the control group are X errors and the only errors that may be propagated from qubits of the target group are Z errors. Because the X and Z errors can each only propagate in one direction, they can be detected at the origin using flag gadgets, providing additional efficiency in the logical qubit preparation.

According to a first aspect of the present disclosure, a method for fault-tolerantly preparing a logical qubit of a QEC code. In an example embodiment, the method includes causing, in accordance with an encoding circuit, performance of a plurality of entangling gates on respective pairs of a plurality of physical qubits. Each entangling gate of the plurality of entangling gates is controlled by a control physical qubit and targets a target physical qubit. The control physical qubit is a member of a control group corresponding to at least one control data qubit of a plurality of data qubits of the logical qubit and the target physical qubit is a member of a target group corresponding to one or more target data qubits of the plurality of data qubits. The control group and the target group are non-overlapping.

In an example embodiment, each control data qubit of the control group is used as the control for at least one entangling gate of the plurality of entangling gates and each target data qubit of the target group is used as the target for at least one entangling gate of the plurality of entangling gates.

In an example embodiment, none of the control data qubits of the control group are used as a target of an entangling gate of the plurality of entangling gates and none of the target data qubits of the target group are used as a control of an entangling gate of the plurality of entangling gates.

In an example embodiment, each data qubit of the plurality of data qubits is a physical qubit and each entangling gate of the plurality of entangling gates is a CNOT gate.

In an example embodiment, the method further includes for a first data qubit of the plurality of data qubits, executing a first flag gadget.

In an example embodiment, the first flag gadget corresponds to a code distance of the QEC code and a number of entangling gates of the plurality of entangling gates to which the first physical qubit is a party.

In an example embodiment, the first flag gadget is inserted into the encoding circuit.

In an example embodiment, the first flag gadget is selected from a plurality of defined flag gadgets based on the code distance of the QEC code and the number of entangling gates to which the first physical qubit is a party.

In an example embodiment, executing the first flag gadget comprises causing entanglement of one or more flag qubits with the first physical qubit at respective entanglement points during the performance of the plurality of entangling gates of the encoding circuit, causing disentanglement of the one or more flag qubits from the first physical qubit at respective disentanglement points during or after the performance of the plurality of entanglement gates of the encoding circuit, and causing performance of measurements of the one or more flag qubits.

In an example embodiment, the method further includes performing a post-selection operation on the logical qubit based on results of the measurements of the one or more flag qubits.

In an example embodiment, the respective entanglement points for each of the one or more flag qubits and the respective disentanglement points for each of the one or more flag qubits are configured such that the flag gadget is able to detect any errors of a weight greater than a tolerance of the QEC code and/or errors that can propagate to a weight that is greater than an original weight of the error.

In an example embodiment, entanglement of the first physical qubit and a flag qubit of the one or more flag qubits is enacted by a controlled entangling gate using the first physical qubit as a control of the controlled entangling gate and using the flag qubit as a target of the controlled entangling gate and disentanglement of the first physical qubit and the flag qubit is enacted by a controlled disentangling gate using the first physical qubit as a control of the controlled disentangling gate and using the flag qubit as a target of the controlled disentangling gate.

In an example embodiment, the method further includes causing performance of a plurality of flag gadgets, wherein each flag gadget corresponds to a respective data qubit of the plurality of data qubits; and performing a post-selection operation on the logical qubit based on results of performing the plurality of flag gadgets.

In an example embodiment, the logical qubit is prepared as a bipartite graph state.

In an example embodiment, the method further includes prior to performing the plurality of entangling gates, preparing a plurality of cat states, each cat state of the plurality of cat states (a) comprising a respective plurality of physical qubits that are entangled with one another and (b) corresponds to a data qubit of the plurality of data qubits of the logical qubit, wherein each entangling gate of the plurality of entangling gates is performed on a pair of physical qubits of different cat states.

In an example embodiment, a selected physical qubit of each cat state is the data qubit to which the cat state corresponds.

In an example embodiment, the method further includes after performance of the plurality of entangling gates, performing a qubit measurement operations on at least one of the respective plurality of physical qubits of the cat state; determining whether to perform a correction on the data qubit corresponding to the cat state based at least in part on a result of performing the qubit measurement operation on the at least one of the respective plurality of physical qubits of the cat state; and responsive to determining to perform the correction on the data qubit, causing performance of the correction on the data qubit.

According to another aspect, a system is provided. In an example embodiment, the system includes a plurality of physical qubits; qubit manipulation elements; and a controller configured to control operation of the qubit manipulation elements to cause, in accordance with an encoding circuit, performance of a plurality of entangling gates on respective pairs of a plurality of physical qubits. Each entangling gate of the plurality of entangling gates is controlled by a control physical qubit and targets a target physical qubit. The control physical qubit is a member of a control group corresponding to at least one control data qubit of a plurality of data qubits of the logical qubit and the target physical qubit is a member of a target group corresponding to one or more target data qubits of the plurality of data qubits. The control group and the target group are non-overlapping.

In an example embodiment, each control data qubit of the control group is used as the control for at least one entangling gate of the plurality of entangling gates and each target data qubit of the target group is used as the target for at least one entangling gate of the plurality of entangling gates.

In an example embodiment, none of the control data qubits of the control group are used as a target of an entangling gate of the plurality of entangling gates and none of the target data qubits of the target group are used as a control of an entangling gate of the plurality of entangling gates.

In an example embodiment, each data qubit of the plurality of data qubits is a physical qubit and each entangling gate of the plurality of entangling gates is a controlled gate.

In an example embodiment, the controller is configured to control operation of the qubit manipulation elements to further cause, for a first data qubit of the plurality of data qubits, executing a first flag gadget.

In an example embodiment, the first flag gadget corresponds to a code distance of the QEC code and a number of entangling gates of the plurality of entangling gates to which the first physical qubit is a party.

In an example embodiment, the first flag gadget is inserted into the encoding circuit.

In an example embodiment, the first flag gadget is selected from a plurality of defined flag gadgets based on the code distance of the QEC code and the number of entangling gates to which the first physical qubit is a party.

In an example embodiment, executing the first flag gadget comprises causing entanglement of one or more flag qubits with the first physical qubit at respective entanglement points during the performance of the plurality of entangling gates of the encoding circuit, causing disentanglement of the one or more flag qubits from the first physical qubit at respective disentanglement points during or after the performance of the plurality of entanglement gates of the encoding circuit, and causing performance of measurements of the one or more flag qubits.

In an example embodiment, the controller is configured to control operation of the qubit manipulation elements to further cause performing a post-selection operation on the logical qubit based on results of the measurements of the one or more flag qubits.

In an example embodiment, the respective entanglement points for each of the one or more flag qubits and the respective disentanglement points for each of the one or more flag qubits are configured such that the flag gadget is able to detect any errors of a weight greater than a tolerance of the QEC code and/or errors that can propagate to a weight that is greater than an original weight of the error.

In an example embodiment, entanglement of the first physical qubit and a flag qubit of the one or more flag qubits is enacted by a controlled entangling gate using the first physical qubit as a control of the controlled entangling gate and using the flag qubit as a target of the controlled entangling gate and disentanglement of the first physical qubit and the flag qubit is enacted by a controlled disentangling gate using the first physical qubit as a control of the controlled disentangling gate and using the flag qubit as a target of the controlled disentangling gate.

In an example embodiment, the controller is configured to control operation of the qubit manipulation elements to further cause performance of a plurality of flag gadgets, wherein each flag gadget corresponds to a respective data qubit of the plurality of data qubits; and performing a post-selection operation on the logical qubit based on results of performing the plurality of flag gadgets.

In an example embodiment, the logical qubit is prepared as a bipartite graph state.

In an example embodiment, the controller is configured to control operation of the qubit manipulation elements to further cause, prior to performing the plurality of entangling gates, preparing a plurality of cat states, each cat state of the plurality of cat states (a) comprising a respective plurality of physical qubits that are entangled with one another and (b) corresponds to a data qubit of the plurality of data qubits of the logical qubit, wherein each entangling gate of the plurality of entangling gates is performed on a pair of physical qubits of different cat states.

In an example embodiment, a selected physical qubit of each cat state is the data qubit to which the cat state corresponds.

In an example embodiment, the controller is configured to control operation of the qubit manipulation elements to further cause, after performance of the plurality of entangling gates, performing a qubit measurement operations on at least one of the respective plurality of physical qubits of the cat state; determining whether to perform a correction on the data qubit corresponding to the cat state based at least in part on a result of performing the qubit measurement operation on the at least one of the respective plurality of physical qubits of the cat state; and responsive to determining to perform the correction on the data qubit, causing performance of the correction on the data qubit.

According to another aspect, a quantum computer controller is provided. In an example embodiment, the quantum computer controller includes at least one classical processing element and a non-transitory classical memory storing computer-executable instructions. The classical memory and computer-executable instructions are configured to, when executed by the at least one classical processing element, cause the controller to cause, in accordance with an encoding circuit, performance of a plurality of entangling gates on respective pairs of a plurality of physical qubits. Each entangling gate of the plurality of entangling gates is controlled by a control physical qubit and targets a target physical qubit. The control physical qubit is a member of a control group corresponding to at least one control data qubit of a plurality of data qubits of the logical qubit and the target physical qubit is a member of a target group corresponding to one or more target data qubits of the plurality of data qubits. The control group and the target group are non-overlapping.

In an example embodiment, each control data qubit of the control group is used as the control for at least one entangling gate of the plurality of entangling gates and each target data qubit of the target group is used as the target for at least one entangling gate of the plurality of entangling gates.

In an example embodiment, none of the control data qubits of the control group are used as a target of an entangling gate of the plurality of entangling gates and none of the target data qubits of the target group are used as a control of an entangling gate of the plurality of entangling gates.

In an example embodiment, each data qubit of the plurality of data qubits is a physical qubit and each entangling gate of the plurality of entangling gates is a controlled gate.

In an example embodiment, the controller is configured to control operation of the qubit manipulation elements to further cause, for a first data qubit of the plurality of data qubits, executing a first flag gadget.

In an example embodiment, the first flag gadget corresponds to a code distance of the QEC code and a number of entangling gates of the plurality of entangling gates to which the first physical qubit is a party.

In an example embodiment, the first flag gadget is inserted into the encoding circuit.

In an example embodiment, the first flag gadget is selected from a plurality of defined flag gadgets based on the code distance of the QEC code and the number of entangling gates to which the first physical qubit is a party.

In an example embodiment, executing the first flag gadget comprises causing entanglement of one or more flag qubits with the first physical qubit at respective entanglement points during the performance of the plurality of entangling gates of the encoding circuit, causing disentanglement of the one or more flag qubits from the first physical qubit at respective disentanglement points during or after the performance of the plurality of entanglement gates of the encoding circuit, and causing performance of measurements of the one or more flag qubits.

In an example embodiment, the controller is configured to control operation of the qubit manipulation elements to further cause performing a post-selection operation on the logical qubit based on results of the measurements of the one or more flag qubits.

In an example embodiment, the respective entanglement points for each of the one or more flag qubits and the respective disentanglement points for each of the one or more flag qubits are configured such that the flag gadget is able to detect any errors of a weight greater than a tolerance of the QEC code and/or errors that can propagate to a weight that is greater than an original weight of the error.

In an example embodiment, entanglement of the first physical qubit and a flag qubit of the one or more flag qubits is enacted by a controlled entangling gate using the first physical qubit as a control of the controlled entangling gate and using the flag qubit as a target of the controlled entangling gate and disentanglement of the first physical qubit and the flag qubit is enacted by a controlled disentangling gate using the first physical qubit as a control of the controlled disentangling gate and using the flag qubit as a target of the controlled disentangling gate.

In an example embodiment, the controller is configured to control operation of the qubit manipulation elements to further cause performance of a plurality of flag gadgets, wherein each flag gadget corresponds to a respective data qubit of the plurality of data qubits; and performing a post-selection operation on the logical qubit based on results of performing the plurality of flag gadgets.

In an example embodiment, the logical qubit is prepared as a bipartite graph state.

In an example embodiment, the controller is configured to control operation of the qubit manipulation elements to further cause, prior to performing the plurality of entangling gates, preparing a plurality of cat states, each cat state of the plurality of cat states (a) comprising a respective plurality of physical qubits that are entangled with one another and (b) corresponds to a data qubit of the plurality of data qubits of the logical qubit, wherein each entangling gate of the plurality of entangling gates is performed on a pair of physical qubits of different cat states.

In an example embodiment, a selected physical qubit of each cat state is the data qubit to which the cat state corresponds.

In an example embodiment, the controller is configured to control operation of the qubit manipulation elements to further cause, after performance of the plurality of entangling gates, performing a qubit measurement operations on at least one of the respective plurality of physical qubits of the cat state; determining whether to perform a correction on the data qubit corresponding to the cat state based at least in part on a result of performing the qubit measurement operation on the at least one of the respective plurality of physical qubits of the cat state; and responsive to determining to perform the correction on the data qubit, causing performance of the correction on the data qubit.

According to another aspect, a method for preparing a logical qubit encoding circuit and/or for encoding a logical qubit is provided. In an example embodiment, the method includes obtaining, by at least one classical processing element, an encoding circuit for a logical qubit of a quantum error correction (QEC) code. The encoding circuit comprises a first plurality of entangling gates on respective pairs of a plurality of data qubits. The plurality of data qubits are entangled by the encoding circuit into the logical qubit. Each entangling gate of the first plurality of entangling gates is controlled by a control data qubit and targets a target data qubit, the control data qubit is a member of a control group comprising at least one data qubit of the plurality of data qubits and the target data qubit is a member of a target group comprising one or more data qubits of the plurality of data qubits. The control group and the target group are non-overlapping. The method further includes for each data qubit of the plurality of data qubits, determining a number of entangling gates performed the data qubit; and defining a plurality of cat state preparation circuits configured to fault tolerantly prepare a plurality of cat states. Each cat state preparation circuit is configured to prepare a respective cat state corresponding to a respective data qubit of the plurality of data qubits and comprising a number of physical qubits equal to the number of entangling gates performed on the data qubit plus one. The method further includes defining a cat state-based encoding circuit based at least in part on the encoding circuit and using the plurality of cat states, wherein the cat state-based encoding circuit is configured to fault tolerantly prepare the logical qubit.

In an example embodiment, obtaining the encoding circuit comprises determining a bipartite graph representation of the logical qubit and generating the encoding circuit based at least in part on the bipartite graph representation of the logical qubit.

In an example embodiment, each entangling gate of the plurality of entangling gates is a controlled two-qubit gate.

In an example embodiment, the controlled two-qubit gate is a controlled-NOT (CNOT) gate.

In an example embodiment, the QEC code is a CSS QEC code.

In an example embodiment, the cat state-based encoding circuit comprises a second plurality of entangling gates and each physical qubit of the plurality of cat states is a party to at most one entangling gate of the second plurality of entangling gates.

In an example embodiment, the second plurality of entangling gates are configured to be performed as a depth one action.

In an example embodiment, the cat state corresponding to the data qubit is a Greenberger-Horne-Zeilinger (GHZ) state.

In an example embodiment, a first cat state corresponding to the target data qubit is a |+>^{k1}+|−>^{k1} GHZ state, where k1 is equal to the number of entangling gates performed on the target data qubit plus one, and a second cat state corresponding to the control data qubit is |0>^{k2}+|1>^{k2} GHZ state, where k2 is equal to the number of entangling gates performed on the control data qubit plus one.

According to another aspect, a classical computing entity or a controller is provided. The classical computing entity or the controller includes a classical processing element and a classical memory storing computer-executable instructions. The memory and computer-executable instructions are configured to, when executed by the classical processing element, cause the classical computing entity or the controller to perform obtaining, by at least one classical processing element, an encoding circuit for a logical qubit of a quantum error correction (QEC) code. The encoding circuit comprises a first plurality of entangling gates on respective pairs of a plurality of data qubits. The plurality of data qubits are entangled by the encoding circuit into the logical qubit. Each entangling gate of the first plurality of entangling gates is controlled by a control data qubit and targets a target data qubit. the control data qubit is a member of a control group comprising at least one data qubit of the plurality of data qubits and the target data qubit is a member of a target group comprising one or more data qubits of the plurality of data qubits. The control group and the target group are non-overlapping. The memory and computer-executable instructions are configured to, when executed by the classical processing element, cause the classical computing entity or the controller to perform, for each data qubit of the plurality of data qubits, determining a number of entangling gates performed the data qubit; and defining a plurality of cat state preparation circuits configured to fault tolerantly prepare a plurality of cat states. Each cat state preparation circuit is configured to prepare a respective cat state corresponding to a respective data qubit of the plurality of data qubits and comprising a number of physical qubits equal to the number of entangling gates performed on the data qubit plus one. The memory and computer-executable instructions are configured to, when executed by the classical processing element, cause the classical computing entity or the controller to perform defining a cat state-based encoding circuit based at least in part on the encoding circuit and using the plurality of cate states, wherein the cat state-based encoding circuit is configured to fault tolerantly prepare the logical qubit.

In an example embodiment, obtaining the encoding circuit comprises determining a bipartite graph representation of the logical qubit and generating the encoding circuit based at least in part on the bipartite graph representation of the logical qubit.

In an example embodiment, each entangling gate of the plurality of entangling gates is a controlled two-qubit gate.

In an example embodiment, the controlled two-qubit gate is a controlled-NOT (CNOT) gate.

In an example embodiment, the QEC code is a CSS QEC code.

In an example embodiment, the cat state-based encoding circuit comprises a second plurality of entangling gates and each physical qubit of the plurality of cat states is a party to at most one entangling gate of the second plurality of entangling gates.

In an example embodiment, the second plurality of entangling gates are configured to be performed as a depth one action.

In an example embodiment, the cat state corresponding to the data qubit is a Greenberger-Horne-Zeilinger (GHZ) state.

In an example embodiment, a first cat state corresponding to the target data qubit is a |+>^{k1}+|−>^{k1} GHZ state, where k1 is equal to the number of entangling gates performed on the target data qubit plus one, and a second cat state corresponding to the control data qubit is |0>^{k2}+|1>^{k2} GHZ state, where k2 is equal to the number of entangling gates performed on the control data qubit plus one.

According to another aspect, a computer program product is provided. In an example embodiment, the computer program product includes at least one non-transitory computer-readable medium storing computer-executable instructions. The computer-executable instructions are configured to, when executed by a classical processing element, cause the classical processing element to perform obtaining, by at least one classical processing element, an encoding circuit for a logical qubit of a quantum error correction (QEC) code. The encoding circuit comprises a first plurality of entangling gates on respective pairs of a plurality of data qubits. The plurality of data qubits are entangled by the encoding circuit into the logical qubit. Each entangling gate of the first plurality of entangling gates is controlled by a control data qubit and targets a target data qubit, the control data qubit is a member of a control group comprising at least one data qubit of the plurality of data qubits and the target data qubit is a member of a target group comprising one or more data qubits of the plurality of data qubits. The control group and the target group are non-overlapping. The computer-executable instructions are further configured to, when executed by a classical processing element, cause the classical processing element to perform, for each data qubit of the plurality of data qubits, determining a number of entangling gates performed the data qubit; and defining a plurality of cat state preparation circuits configured to fault tolerantly prepare a plurality of cat states. Each cat state preparation circuit is configured to prepare a respective cat state corresponding to a respective data qubit of the plurality of data qubits and comprising a number of physical qubits equal to the number of entangling gates performed on the data qubit plus one. The computer-executable instructions are further configured to, when executed by a classical processing element, cause the classical processing element to perform defining a cat state-based encoding circuit based at least in part on the encoding circuit and using the plurality of cate states, wherein the cat state-based encoding circuit is configured to fault tolerantly prepare the logical qubit.

In an example embodiment, obtaining the encoding circuit comprises determining a bipartite graph representation of the logical qubit and generating the encoding circuit based at least in part on the bipartite graph representation of the logical qubit.

In an example embodiment, each entangling gate of the plurality of entangling gates is a controlled two-qubit gate.

In an example embodiment, the controlled two-qubit gate is a controlled-NOT (CNOT) gate.

In an example embodiment, the QEC code is a CSS QEC code.

In an example embodiment, the cat state-based encoding circuit comprises a second plurality of entangling gates and each physical qubit of the plurality of cat states is a party to at most one entangling gate of the second plurality of entangling gates.

In an example embodiment, the second plurality of entangling gates are configured to be performed as a depth one action.

In an example embodiment, the cat state corresponding to the data qubit is a Greenberger-Horne-Zeilinger (GHZ) state.

In an example embodiment, a first cat state corresponding to the target data qubit is a |+>^{k1}+|−>^{k1} GHZ state, where k1 is equal to the number of entangling gates performed on the target data qubit plus one, and a second cat state corresponding to the control data qubit is |0>^{k2}+|1>^{k2} GHZ state, where k2 is equal to the number of entangling gates performed on the control data qubit plus one.

According to another aspect, a method for causing preparation of a logical qubit generation circuit is provided. In an example embodiment, the method includes obtaining, by at least one classical processing element, an encoding circuit for a logical qubit of a quantum error correction (QEC) code. The encoding circuit comprises a plurality of entangling gates on respective pairs of a plurality of data qubits. Each entangling gate of the plurality of entangling gates is controlled by a control data qubit and targets a target data qubit. The control data qubit is a member of a control group comprising at least one data qubit of the plurality of data qubits and the target data qubit is a member of a target group comprising one or more data qubits of the plurality of data qubits. The control group and the target group are non-overlapping. In example embodiment, the method further includes inserting, by the at least one classical processing element, one or more flag gadgets into the encoding circuit to form a logical qubit preparation circuit; and causing, by the at least one classical processing element, a quantum computer to execute the logical preparation circuit to prepare the logical qubit.

In an example embodiment, obtaining the encoding circuit comprises determining a bipartite graph representation of the logical qubit and generating the encoding circuit based at least in part on the bipartite graph representation of the logical qubit.

In an example embodiment, each flag gadget of the one or more flag gadgets corresponds to a respective data qubit of the plurality of data qubits and has as structure determined based on a code distance the QEC code and a number of entangling gates of the encoding circuit to which the respective data qubit is a party.

In an example embodiment, the method further includes determining the code distance associated with the QEC code; determining the number of entangling gates of the encoding circuit to which the respective data qubit is a party; and selecting a flag gadget corresponding to the respective data qubit from a plurality of defined flag gadgets based on the code distance and the number of entangling gates of the encoding circuit to which the respective data qubit is a party.

In an example embodiment, the flag gadget is configured to detect whether the respective data qubit experienced any errors of a weight greater than a tolerance of the QEC code and/or errors that can propagate to a weight that is greater than an original weight of the error.

In an example embodiment, the one or more flag gadgets comprise respective flag gadgets corresponding to each data qubit of the plurality of data qubits.

In an example embodiment, each entangling gate of the plurality of entangling gates is a controlled two-qubit gate.

In an example embodiment, the controlled two-qubit gate is a controlled-NOT (CNOT) gate.

In an example embodiment, the QEC code is a CSS QEC code.

According to another aspect, a classical computing entity or a controller is provided. The classical computing entity or the controller includes a classical processing element and a classical memory storing computer-executable instructions. The memory and computer-executable instructions are configured to, when executed by the classical processing element, cause the classical computing entity or the controller to perform obtaining an encoding circuit for a logical qubit of a quantum error correction (QEC) code. The encoding circuit comprises a plurality of entangling gates on respective pairs of a plurality of data qubits. Each entangling gate of the plurality of entangling gates is controlled by a control data qubit and targets a target data qubit. The control data qubit is a member of a control group comprising at least one data qubit of the plurality of data qubits and the target data qubit is a member of a target group comprising one or more data qubits of the plurality of data qubits. The control group and the target group are non-overlapping. The memory and computer-executable instructions are further configured to, when executed by the classical processing element, cause the classical computing entity or the controller to perform inserting one or more flag gadgets into the encoding circuit to form a logical qubit preparation circuit; and causing a quantum computer to execute the logical preparation circuit to prepare the logical qubit.

In an example embodiment, obtaining the encoding circuit comprises determining a bipartite graph representation of the logical qubit and generating the encoding circuit based at least in part on the bipartite graph representation of the logical qubit.

In an example embodiment, each flag gadget of the one or more flag gadgets corresponds to a respective data qubit of the plurality of data qubits and has as structure determined based on a code distance the QEC code and a number of entangling gates of the encoding circuit to which the respective data qubit is a party.

In an example embodiment, the memory and computer-executable instructions are further configured to, when executed by the classical processing element, cause the classical computing entity or the controller to perform determining the code distance associated with the QEC code; determining the number of entangling gates of the encoding circuit to which the respective data qubit is a party; and selecting a flag gadget corresponding to the respective data qubit from a plurality of defined flag gadgets based on the code distance and the number of entangling gates of the encoding circuit to which the respective data qubit is a party.

In an example embodiment, the flag gadget is configured to detect whether the respective data qubit experienced any errors of a weight greater than a tolerance of the QEC code and/or errors that can propagate to a weight that is greater than an original weight of the error.

In an example embodiment, the one or more flag gadgets comprise respective flag gadgets corresponding to each data qubit of the plurality of data qubits.

In an example embodiment, each entangling gate of the plurality of entangling gates is a controlled two-qubit gate.

In an example embodiment, the controlled two-qubit gate is a controlled-NOT (CNOT) gate.

In an example embodiment, the QEC code is a CSS QEC code.

According to another aspect, a computer program product is provided. In an example embodiment, the computer program product includes at least one non-transitory computer-readable medium storing computer-executable instructions. The computer-executable instructions are configured to, when executed by a classical processing element, cause the classical processing element to perform obtaining an encoding circuit for a logical qubit of a quantum error correction (QEC) code. The encoding circuit comprises a plurality of entangling gates on respective pairs of a plurality of data qubits. Each entangling gate of the plurality of entangling gates is controlled by a control data qubit and targets a target data qubit. The control data qubit is a member of a control group comprising at least one data qubit of the plurality of data qubits and the target data qubit is a member of a target group comprising one or more data qubits of the plurality of data qubits. The control group and the target group are non-overlapping. The computer-executable instructions are further configured to, when executed by a classical processing element, cause the classical processing element to perform inserting one or more flag gadgets into the encoding circuit to form a logical qubit preparation circuit; and causing a quantum computer to execute the logical preparation circuit to prepare the logical qubit.

In an example embodiment, obtaining the encoding circuit comprises determining a bipartite graph representation of the logical qubit and generating the encoding circuit based at least in part on the bipartite graph representation of the logical qubit.

In an example embodiment, each flag gadget of the one or more flag gadgets corresponds to a respective data qubit of the plurality of data qubits and has as structure determined based on a code distance the QEC code and a number of entangling gates of the encoding circuit to which the respective data qubit is a party.

In an example embodiment, the memory and computer-executable instructions are further configured to, when executed by the classical processing element, cause the classical computing entity or the controller to perform determining the code distance associated with the QEC code; determining the number of entangling gates of the encoding circuit to which the respective data qubit is a party; and selecting a flag gadget corresponding to the respective data qubit from a plurality of defined flag gadgets based on the code distance and the number of entangling gates of the encoding circuit to which the respective data qubit is a party.

In an example embodiment, the flag gadget is configured to detect whether the respective data qubit experienced any errors of a weight greater than a tolerance of the QEC code and/or errors that can propagate to a weight that is greater than an original weight of the error.

In an example embodiment, the one or more flag gadgets comprise respective flag gadgets corresponding to each data qubit of the plurality of data qubits.

In an example embodiment, each entangling gate of the plurality of entangling gates is a controlled two-qubit gate.

In an example embodiment, the controlled two-qubit gate is a controlled-NOT (CNOT) gate.

In an example embodiment, the QEC code is a CSS QEC code.

According to another aspect, a method is provided. In an example embodiment, the method includes obtaining, by a classical processor, a code distance, a number of gates, and an initial upper bound. The method further includes performing, by the classical processor, one or more iterations of determining, by the classical processor, whether an error propagation model is able to generate a flag gadget that is capable of identifying any errors up to a weight corresponding to a code distance and/or errors that can propagate to a weight that is greater than an original weight of the error within a sequence of entangling gates consisting of the number of gates worth of entangling gates and using a number of flag qubits equal to the initial upper bound minus an iteration number; responsive to determining that the error propagation model is able to generate the flag gadget, updating the iteration number and initiating another iteration; and responsive to determining that the error propagation model is not able to generate the flag gadget, causing an indication that the error propagation model is not able to generate the flag gadget to be provided and ceasing the performing of the one or more iterations.

In an example embodiment, the method further includes, prior to the performing the one or more iterations, resetting the iteration number to an initial iteration value, wherein updating the iteration number consist of adding a set positive integer to the iteration number.

In an example embodiment, the method further includes generating the flag gadget and providing or causing storage of the flag gadget in association with the code distance and the number of gates.

In an example embodiment, the flag gadget is further associated with an upper bound value equal to the initial upper bound minus the iteration number of an iteration in which the flag gadget was generated.

In an example embodiment, the flag gadget is stored in a flag gadget database.

In an example embodiment, the flag gadget is indexed within the flag gadget database by the code distance and the number of gates.

According to another aspect, a classical computing entity is provided. In an example embodiment, the classical computing entity includes a classical processing element and a classical memory storing computer-executable instructions. The memory and computer-executable instructions are configured to, when executed by the classical processor, cause the classical computing entity to perform obtaining a code distance, a number of gates, and an initial upper bound. The memory and computer-executable instructions are further configured to, when executed by the classical processor, cause the classical computing entity to perform one or more iterations of determining whether an error propagation model is able to generate a flag gadget that is capable of identifying any errors up to a weight corresponding to a code distance and/or errors that can propagate to a weight that is greater than an original weight of the error within a sequence of entangling gates consisting of the number of gates worth of entangling gates and using a number of flag qubits equal to the initial upper bound minus an iteration number; responsive to determining that the error propagation model is able to generate the flag gadget, updating the iteration number and initiating another iteration; and responsive to determining that the error propagation model is not able to generate the flag gadget, causing an indication that the error propagation model is not able to generate the flag gadget to be provided and ceasing the performing of the one or more iterations.

In an example embodiment, the memory and computer-executable instructions are further configured to, when executed by the classical processor, cause the classical computing entity to perform, prior to the performing the one or more iterations, resetting the iteration number to an initial iteration value, wherein updating the iteration number consist of adding a set positive integer to the iteration number.

In an example embodiment, the method further includes generating the flag gadget and providing or causing storage of the flag gadget in association with the code distance and the number of gates.

In an example embodiment, the flag gadget is further associated with an upper bound value equal to the initial upper bound minus the iteration number of an iteration in which the flag gadget was generated.

In an example embodiment, the flag gadget is stored in a flag gadget database.

In an example embodiment, the flag gadget is indexed within the flag gadget database by the code distance and the number of gates.

According to another aspect, a computer program product is provided. In an example embodiment, the computer program product includes at least one non-transitory computer-readable medium storing computer-executable instructions. The computer-executable instructions are configured to, when executed by a classical processing element, cause the classical processing element to perform obtaining a code distance, a number of gates, and an initial upper bound. The memory and computer-executable instructions are further configured to, when executed by the classical processor, cause the classical computing entity to perform one or more iterations of determining whether an error propagation model is able to generate a flag gadget that is capable of identifying any errors up to a weight corresponding to a code distance and/or errors that can propagate to a weight that is greater than an original weight of the error within a sequence of entangling gates consisting of the number of gates worth of entangling gates and using a number of flag qubits equal to the initial upper bound minus an iteration number; responsive to determining that the error propagation model is able to generate the flag gadget, updating the iteration number and initiating another iteration; and responsive to determining that the error propagation model is not able to generate the flag gadget, causing an indication that the error propagation model is not able to generate the flag gadget to be provided and ceasing the performing of the one or more iterations.

In an example embodiment, the computer-executable instructions are further configured to, when executed by a classical processing element, cause the classical processing element to perform, prior to the performing the one or more iterations, resetting the iteration number to an initial iteration value, wherein updating the iteration number consist of adding a set positive integer to the iteration number.

In an example embodiment, the method further includes generating the flag gadget and providing or causing storage of the flag gadget in association with the code distance and the number of gates.

In an example embodiment, the flag gadget is further associated with an upper bound value equal to the initial upper bound minus the iteration number of an iteration in which the flag gadget was generated.

In an example embodiment, the flag gadget is stored in a flag gadget database.

In an example embodiment, the flag gadget is indexed within the flag gadget database by the code distance and the number of gates.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example hybrid quantum-classical computing system, according to an example embodiment.

FIG. 2 is a schematic illustration of an example logical qubit (of the [[7, 1, 3]] Steane Code) as a bipartite graph, in accordance with certain embodiments.

FIG. 3 provides a circuit diagram of an encoding circuit for encoding the example logical qubit shown in FIG. 2 in the logical |0> state, in accordance with certain embodiments.

FIG. 4 provides a circuit diagram of a portion of a logical qubit preparation circuit that includes the encoding circuit shown in FIG. 3 and two flag gadgets, in accordance with certain embodiments.

FIG. 5 provides a circuit diagram of a portion of a logical qubit preparation circuit for preparing a logical qubit of the five-qubit error correcting code that includes an encoding circuit and a flag gadget for the control qubit of the plurality of data qubits of the digital qubit, in accordance with certain embodiments.

FIG. 6 provides a flowchart illustrating various processes and/or procedures performed by a controller of FIG. 14 or a classical computing entity of FIG. 15, for example, preparing and/or providing a (fault-tolerant) logical qubit preparation circuit, in accordance with certain embodiments.

FIG. 7 provides a flowchart illustrating various processes and/or procedures performed by a controller of FIG. 14, for example, for preparing a logical qubit in accordance with a QEC code, in accordance with certain embodiments.

FIG. 8 provides a flowchart illustrating various processes and/or procedures performed by a controller of FIG. 14, for example, for executing a flag gadget, in accordance with certain embodiments.

FIG. 9 provides a flowchart illustrating various processes and/or procedures performed by a classical computing entity of FIG. 15, for example, for determining a minimal upper limit on the number of flag qubits in a flag gadget and/or for generating a flag gadget, in accordance with certain embodiments.

FIG. 10A provides a circuit diagram of an encoding circuit for fault tolerantly encoding the example logical qubit shown in FIG. 2 in the logical |0> state, in accordance with certain embodiments.

FIG. 10B provides a circuit diagram of another encoding circuit for fault tolerantly encoding the example logical qubit shown in FIG. 2 in the logical |0> state, in accordance with certain embodiments.

FIG. 11 provides a flowchart illustrating various processes and/or procedures performed by a controller of FIG. 14 or a classical computing entity of FIG. 15, for example, for preparing and/or providing a cat state-based fault-tolerant logical qubit preparation circuit, in accordance with certain embodiments.

FIG. 12A provides a circuit diagram of an example fault-tolerant cat state preparation circuit, in accordance with certain embodiments.

FIG. 12B provides a flowchart illustrating various processes and/or procedures performed by a controller of FIG. 14 or a classical computing entity of FIG. 15, for example, to fault tolerantly prepare a cat state, in accordance with certain embodiments.

FIG. 13 provides a flowchart illustrating various processes and/or procedures performed by a controller of FIG. 14 or a classical computing entity of FIG. 15, for example, to fault tolerantly prepare a logical qubit using a cat state-based encoding circuit, in accordance with certain embodiments.

FIG. 14 provides a schematic diagram of an example controller of a quantum component of a hybrid-classical computing system that is configured to control operation of one or more elements of the quantum component, according to various embodiments.

FIG. 15 provides a schematic diagram of an example classical component of a hybrid quantum-classical computing system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Complex quantum computations demand levels of precision that are not available in conventional quantum computers due to imperfect control and noise in gate operations between data qubits, for example. Proposed schemes for quantum error correction (QEC) include the organization of data qubits into logical qubits in accordance with a selected QEC code. Each QEC code is associated with and/or labeled by a code distance that indicates the number of errors or error weight to which the QEC code is robust. For the use of logical qubits to provide fault-tolerant quantum computing, the logical qubits must be prepared in a fault-tolerant manner. However, the preparation of logical qubits is not optimized and may often include too many errors to provide a fault tolerant logical qubit preparation. Therefore, technical problems exist regarding preparation of logical qubits in a fault-tolerant manner.

Various embodiments provide technical solutions to these technical problems. For example, various embodiments provide methods, systems, apparatus, computer program products, and/or the like for preparing logical qubits in accordance with a CSS QEC code. For example, in various embodiments, a logical qubit includes a plurality of data qubits that are entangled in accordance with a particular (CSS) QEC code. The data qubits are physical qubits of the quantum computer/processor. The plurality of data qubits of a logical qubit are divided into a control group and a target group. During the logical qubit preparation, the physical qubits of the control group are used as the control qubits in performing CNOT gates on respective physical qubits of the target group. In other words, the logical qubit is prepared as a bipartite graph state. For example, the encoding circuit for preparing the logical qubit includes a plurality of CNOT gates that each include a respective control qubit from the control group of data qubits and a respective target qubit from the target group of data qubits. This provides for improved efficiency of the preparation of the logical qubit. This enables a more efficient preparation of the logical qubits and limits the errors that can occur and/or be propagated through the preparation of the logical qubit.

In particular, as a result of the structure of the encoding circuit, the only errors that may be propagated to qubits of the control group are X errors and the only errors that may be propagated to qubits of the target group are Z errors. Because the X and Z errors can each only propagate in one direction, they can be detected at the origin using flag gadgets, providing additional efficiency in the logical qubit preparation.

Each flag gadget includes entangling one or more ancilla/flag qubits with a data qubit of the logical qubit at a first respective point during preparation of the logical qubit (e.g., via a CNOT gate controlled by the physical qubit), un-entangling the ancilla/flag qubit(s) with the physical qubit at a second respective point, and measuring the flag/ancilla qubit(s). The first respective points, second respective points, and the number of ancilla/flag qubits are determined such that any errors of a weight greater than the tolerance of the code and/or errors that can propagate to a weight that is greater than an original weight of the error are identified. Post-selection based on the measurements of the ancilla/flag qubits may be used to ensure a fault-tolerant preparation of the logical qubit.

Moreover, as the structure of the flag gadget applied to a data qubit is determined based only on the distance of the QEC code and the number of CNOT gates applied to the data qubit in the encoding circuit, flag gadgets for a broad range of (CSS) QEC codes may be predetermined and implemented in a modular manner when preparing the logical qubit preparation circuit.

According to various embodiments, to optimize a flag gadget, it may be determined if a flag gadget having p ancilla/flag qubits that is capable of identifying errors of an appropriate weight for the distance of the code exists. If such a flag gadget exists, p is an upper bound on the minimum number of ancilla/flag qubits required for the flag gadget. It may then be determined whether a flag gadget having p−1 ancilla/flag qubits and that is able to identify errors of an appropriate weight for the code exists. This process may be continued until a solution with a smaller number of ancilla/flag qubits cannot be identified such that a minimal upper bound on the minimum number of ancilla/flag qubits for a particular flag gadget (corresponding to a code distance and number of CNOT gates) is determined.

Therefore, various embodiments provide an efficient fault-tolerant preparation of logical qubits that may include the inclusion of modular, predetermined/generated flag gadgets that can be inserted into an encoding circuit to generate an efficient and fault-tolerant logical qubit preparation circuit. Thus, various embodiments provide technical improvements to the fields of quantum computing, fault-tolerant quantum computing, fault-tolerant logical qubit preparation, and/or the like.

### Example Quantum Computing System

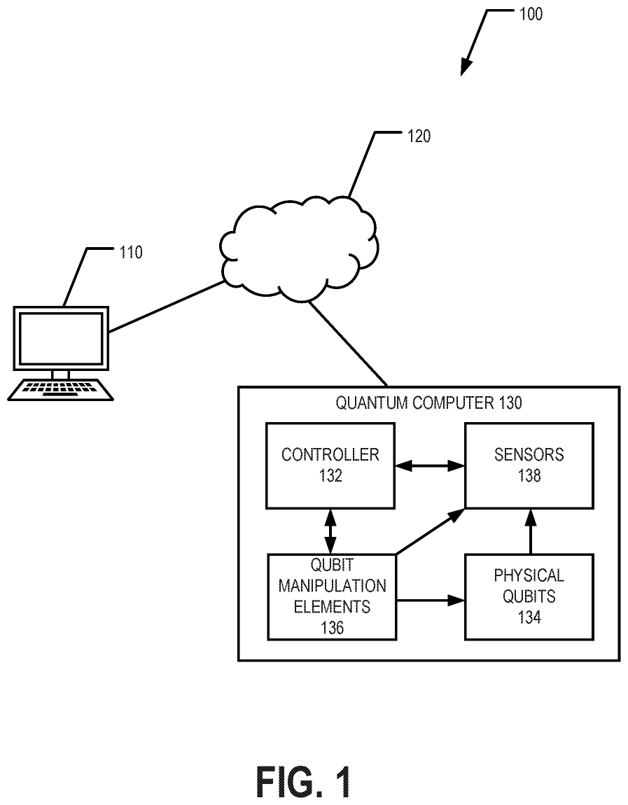

FIG. 1 provides a block diagram of an example quantum computing system 100, in accordance with various embodiments. In various embodiments, the quantum computing system 100 comprises a classical computing entity 110 and a quantum computer 130.

The quantum computer 130 comprises a controller 132, a plurality of physical qubits 134, qubit manipulation elements 136, and sensors 138. The controller 132 is configured to control operation of the qubit manipulation elements 136 to cause desired manipulations (e.g., controlled quantum state evolution) of the physical qubits 134. The controller 132 is further configured to control operation of the sensors 138 that are configured to monitor, measure, and/or capture measurements corresponding to the operation of the qubit manipulation elements and detect observables indicating the respective quantum states of respective physical qubits 134.

For example, in various embodiments, the qubit manipulation elements 136 comprise voltage/current sources, laser sources, microwave sources, magnetic field sources (e.g., electromagnets and/or permanent magnets), and/or other hardware components configured for use in confining the qubits and/or manipulating the quantum state of the physical qubits.

In various embodiments, the sensors 138 comprise photodetectors, voltage/current sensors, temperature sensors, pressure sensors, and/or other sensors that may be used to determine a quantum state of a physical qubit and/or monitor operation of one or more of the qubit manipulation elements 136.

In various embodiments, the physical qubits 134 are quantum systems that may be manipulated via the qubit manipulation elements 136 such that operation of the qubit manipulation elements 136 control evolution of the quantum states of the physical qubits 134. Some non-limiting examples of quantum systems that may be used as physical qubits in various embodiments include photons, electrons, atomic nuclei, neutral atoms, ions, Josephson junctions, quantum dots, topological anyons, and/or other quantum particles and/or systems.

In various embodiments, the classical computing entity 110 is in communication with the controller 132 of the quantum computer 130 via one or more wired or wireless networks 120 and/or via direct wired and/or wireless communications. For example, the classical computing entity 110 is configured to provide quantum circuits to the quantum computer 130 (e.g., the controller 132 thereof) and receive measurement results corresponding to performance of measurements of the quantum states of physical qubits as a result of performing quantum circuits via the one or more wired or wireless networks 120 and/or via direct wired and/or wireless communications between the classical computing entity 110 and the quantum computer 130. In various embodiments, a quantum circuit is a sequence of quantum gates and/or unitary transformations to be performed on the plurality of physical qubits 134 and may include measurement operations to be performed to determine respective quantum states of physical qubits as a result of performance of at least a portion of the sequence of quantum gates and/or unitary transformations. The quantum computer 130 is configured to receive quantum circuits provided by the classical computing entity 110 and provide measurement results generated by performing the quantum circuits for receipt by the classical computing entity 110 via the one or more wired or wireless networks 120 and/or via direct wired and/or wireless communications between the classical computing entity 110 and the quantum computer 130.

### Example Logical Qubit Preparation

Physical qubits, the fundamental units of quantum information, are susceptible to noise that occurs during quantum computation. A proposed solution configured to enable accurate computations to be performed in spite of at least some types of errors that may occur is to logically organize the physical qubits into logical qubits using a quantum error correction (QEC) code. For example, a QEC code may be used to encode a logical qubit state using a plurality of data qubits (e.g., physical qubits of the quantum computer), enable checks or measurements to identify that errors have occurred, and, for some errors, provide specific operations to correct a detected error and restore a logical qubit to the correct logical qubit state.

QEC codes are often described by a set of three number [[n, k, d]], which indicate that the QEC code uses n physical qubits to encode k logical qubits having a code distance of d. For example, a code block of the QEC code includes n data qubits and encodes k logical qubits. The logical qubits of such a QEC code is robust and/or fault-tolerant to up to FLOOR(d/2) errors, where FLOOR(x) is a function that rounds x down to the largest integer that is not larger than x. In some embodiments, individual logical qubits are prepared and/or encoded independently. In certain embodiments, logical qubits of a code block are prepared and/or encoded simultaneously. For example, one encoding circuit may be used to prepare and/or encode each logical qubit of a code block.

CSS QEC codes are a category of stabilizer QEC codes that are built from classical error correcting codes. Some non-limiting examples of CSS QEC codes include color codes, surface codes, Golay code, toric codes, and Steane codes.

Various embodiments provide methods, apparatus, systems, computer program products, and/or the like for fault-tolerantly preparing a logical qubit of a QEC code. The disclosed techniques provide for fault-tolerant preparation of a logical qubit of a variety of QEC codes. Moreover, the disclosed techniques provide for fault-tolerant preparation of a logical qubit of any CSS QEC code.

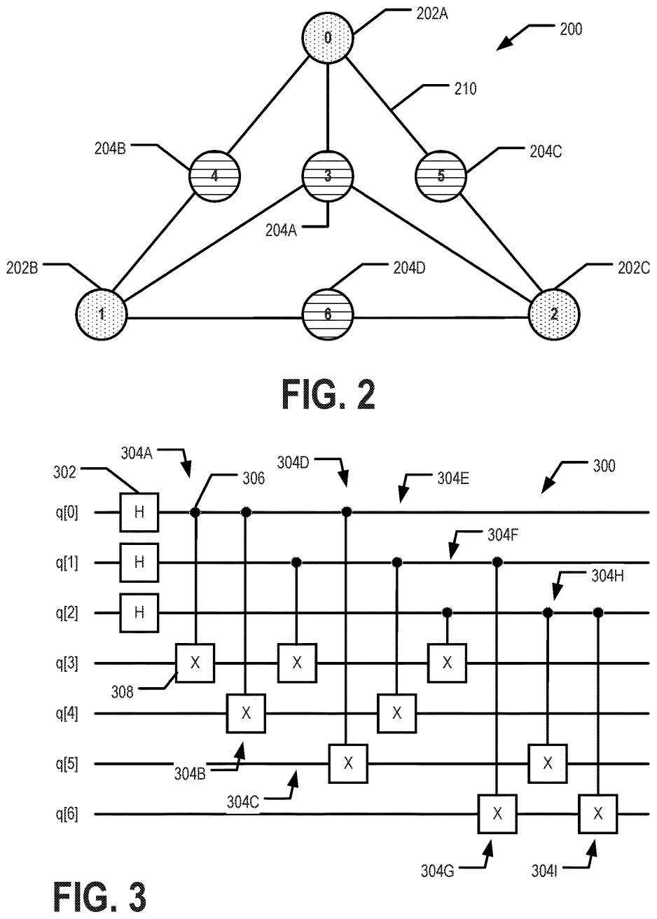

FIG. 2 provides an illustration of an example logical qubit 200 of the [[7, 1, 3]] Steane code. The logical qubit 200 includes seven data qubits 202A, 202B, 202C, 204A, 204B, 204C, 204D and is used to encode one logical qubit. The data qubits 202A-C, 204A-D are physical qubits 134 of the quantum computer 130. The edges 210 indicate interactions or entanglements between the physical qubits that are used to encode the logical qubit 200.

The logical qubit 200 has been organized and/or represented in FIG. 2 as a bipartite graph. A bipartite graph is a graph whose vertices (e.g., the data qubits 202A-C, 204A-D) can be divided into two disjoint sets, such that every edge 210 connects a vertex from one set (e.g., one of data qubits 202A-C) to a vertex from the other set (e.g., one of data qubits 204A-D). In simpler terms, it's a graph where you can split the vertices (e.g., physical qubits) into two groups, and no nodes within the same group are connected by an edge 210.

In various embodiments, a logical qubit of the QEC code is partitioned into a bipartite graph. For example, the plurality of data qubits of the logical qubit are assigned or partitioned into two non-overlapping groups-a control group including data qubits 202A-202C and a target group including data qubits 204A-204D, in the illustrated example.

FIG. 3 illustrates a circuit diagram of an encoding circuit 300 of an example embodiment that is used to encode the data qubits 202A-C, 204A-D into the logical qubit 200. In particular, an encoding circuit is a sequence of quantum gates and/or unitary transformations used to encode a logical qubit state onto a plurality of data qubits. The circuit diagram shown in FIG. 3 includes a plurality of qubit wires (shown as horizontal lines) that each represent one of the data qubits of the logical qubit. The qubit wires labeled q[0], q[1], and q[2] correspond to data qubits 202A-C, respectively, which were assigned to the control group and the qubit wires labeled q[3], q[4], q[5], q[6], correspond to data qubits 204A-D, respectively, which were assigned to the target group. Prior to beginning the encoding circuit, each of the data qubits are initialized into the physical qubit state |0>.

The encoding circuit 300 begins (e.g., at the left side of the qubit wires) with all of the data qubits in the physical qubit state |0> and then causes evolution of the physical qubit states of the data qubits of the control group (q[0], q[1], q[2]) into the physical qubit state |+> through application of a single qubit Hadamard gate 302 to each data qubit of the control group (e.g., when the encoding circuit is configured to prepare the logical qubit in the logical |0> state). The remainder of the encoding circuit includes entangling the data qubits of the control group with the data qubits of the target group via a plurality of entangling gates 304 (e.g., 304A-304I). In various embodiments, each entangling gate is a controlled two-qubit gate that is controlled by one physical qubit and targets a different physical qubit. For example, the effect of the entangling gate on the target qubit is a function of the quantum state of the control qubit. In the illustrated example, the entangling gates 304 are controlled-NOT (CNOT) gates.

For each entangling gate 304 of the encoding circuit, a data qubit of the control group (q[0], q[1], q[2]) is used as the control qubit 306 of the entangling gate 304 and a data qubit of the target group (q[3], q[4], q[5], q[6]) is used as the target 308 of the entangling gate 304. The entangling gates 304 are performed so as to provide the entanglement of the data qubits indicated by edges 210 corresponding to the QEC code.

As can be seen in the example circuit diagram of FIG. 3, in an encoding circuit, each control data qubit of the control group is used as the control for at least one entangling gate 304 (e.g., CNOT gate) of the plurality of entangling gates and each target data qubit of the target group is used as the target for at least one entangling gate 304 (e.g., CNOT gate) of the plurality of entangling gates. In the encoding circuit, none of the control data qubits of the control group are used as a target of an entangling gate of the plurality of entangling gates and none of the target data qubits of the target group are used as a control of an entangling gate of the plurality of entangling gates. In other words, the logical qubit is prepared as a bipartite graph state.

The encoding circuit is configured to encode a logical qubit state onto a plurality of data qubits in accordance with a QEC code. Moreover, the bipartite structure of the encoding circuits of example embodiments controls how errors are able to propagate through the encoding circuits. In particular, as a result of the structure of the encoding circuit, the only errors that may be propagated to data qubits of the control group are X errors and the only errors that may be propagated to data qubits of the target group are Z errors. Because the X and Z errors can each only propagate in one direction, they can be detected at the origin using flag gadgets.

In various embodiments, to ensure that the logical qubit state is encoded onto the plurality of data qubits in a fault-tolerant manner, one or more flag gadgets may be modularly added to the encoding circuit to provide a fault-tolerant logical qubit preparation circuit. A flag gadget is a sequence of quantum operations or unitary transformations that encode information from a single data qubit onto one or more flag or ancilla qubits (referred to as flag qubits herein). The flag or ancilla qubits are physical qubits 134 of the quantum computer 130. The flag gadget further includes performing a measurement of each of the flag qubits of the flag gadget to determine and/or measure the quantum states thereof. For example, the information regarding data qubit that was encoded onto the flag qubit(s) may be extracted from the flag qubit(s) by performing measurement operations on the flag qubit(s). The information regarding the single data qubit that is encoded onto the flag qubit(s) may be used to determine whether the data qubit experienced an error. In some embodiments, the information regarding the single data qubit that is encoded onto the flag qubit(s) may be used to determine when (e.g., where in the encoding circuit that the flag gadget was added to) the data qubit experienced the error and/or to categorize the error that the data qubit experienced.

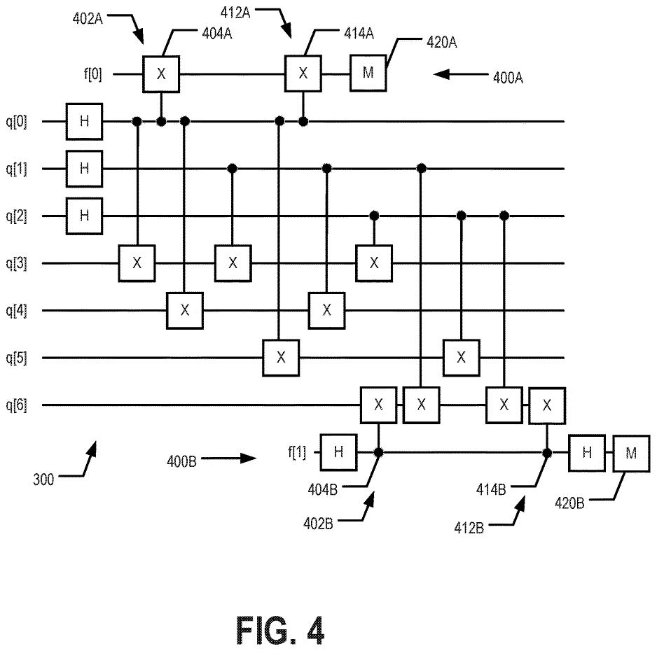

FIG. 4 provides a circuit diagram of at least a portion of a logical qubit preparation circuit that includes the encoding circuit 300 and flag gadgets 400A, 400B have been added to the encoding circuit 300. First flag gadget 400A is configured to detect errors experienced by control data qubit q[0] that have a weight that is greater than the tolerance of the QEC code (e.g., any errors of weight larger than d/2 where d is the code distance of the QEC code) and/or that may propagate to a weight greater than the original weight. For example, the first flag gadget 400A encodes information regarding a first qubit (e.g., control data qubit q[0]) onto one or more first flag qubits (just one flag qubit f[0], in the illustrated embodiment) such that information regarding errors experienced by the first qubit may be extracted without affecting data qubits of the logical qubit. Flag gadget 400B is configured to detect errors experienced by the target data qubit q[6] that have a weight that is equal to and/or greater than the tolerance of the QEC code and/or may propagate to a weight that is greater than the original weight.

As shown in FIG. 4, a flag gadget 400 (e.g., 400A, 400B) generally includes causing entanglement of one or more flag qubits with a corresponding data qubit at respective entanglement points 402 (e.g., 402A, 402B). For example, for each flag qubit, an entangling gate 404 (e.g., 404A, 404B) is performed on the flag qubit and the data qubit corresponding to the flag gadget at a respective entanglement point 402. The entangling gate 404 is a CNOT gate controlled by the data qubit and targeting the flag qubit, in various embodiments. A flag gadget 400 (e.g., 400A, 400B) further includes causing disentanglement of the one or more flag qubits with the corresponding data qubit at respective disentanglement points 412 (e.g., 412A, 412B). For example, a disentangling gate 414 (e.g., 414A, 414B) may be performed on a respective flag qubit and the corresponding data qubit at the respective disentanglement point 412. The disentangling gate 414 is a CNOT gate controlled by the data qubit and targeting the flag qubit, in various embodiments. In some embodiments, a flag gadget (see flag gadget 400B) includes a Hadamard gate prior to performance of the entangling gate 404B and a Hadamard gate after performance of the disentangling gate 414B and prior to performance of measurement 420B. The flag gadget 400 (e.g., 400A, 400B) further includes performing measurements 420 (e.g., 420A, 420B) of each of the flag qubits. In an example embodiment, the measurements performed on the flag qubits of flag gadgets corresponding to control data qubits are performed in the Z-basis and the measurements performed on the flag qubits of flag gadgets corresponding to target data qubits are performed in the X-basis.

Based on the results of the measurements of the one or more flag qubits of the flag gadget, a determination of whether the data qubit corresponding to the flag gadget experienced errors of a weight equal to and/or greater than the tolerance of the QEC code and/or errors that may propagate to a weight that is greater than the original weight during performance of the encoding circuit.

In some embodiments, a flag gadget is inserted into the encoding circuit for each data qubit of the logical qubit. For example, while FIG. 4 illustrates two flag gadgets 400A, 400B inserted into the encoding circuit 300, in certain embodiments, flag gadgets corresponding to data qubits q[1], q[2], q[3], q[4], and q[5] would also be inserted into the encoding circuit 300 to provide a fully fault-tolerant logical qubit preparation circuit.

In some embodiments, the results of the measurements of the flag gadgets are used to determine whether performance of a logical qubit preparation circuit was successful and/or whether the logical qubit was prepared in a fault tolerant manner. For example, a post-selection operation may be performed based at least in part on the measurement results of the flag qubits to determine whether the logical qubit was successfully and/or fault-tolerantly prepared. Responsive to a determination that the logical qubit was successfully and/or fault-tolerantly prepared, various quantum computations, quantum algorithms, and/or quantum circuits may be performed using the logical qubit. Responsive to a determination that the logical qubit was not successfully and/or fault-tolerantly prepared, the data qubits of the logical qubit may be re-initialized (e.g., into the physical qubit state |0>) and the logical qubit preparation circuit may be performed on the data qubits again.

The structure of a flag gadget inserted into an encoding circuit corresponding to a data qubit of the logical qubit being prepared is determined based on the code distance d of the QEC code and the number of entangling gates 304 (e.g., CNOT gates) of the encoding circuit to which the data qubit is a party. In other words, the number of flag qubits in a flag gadget, the respective entangling point for each flag qubit of the flag gadget, and the respective disentanglement point for each flag qubit of the flag gadget is determined based on the code distance d of the QEC code and the number of entangling gates (e.g., CNOT gates) of the encoding circuit to which the data qubit is a party.

For example, the data qubit q[0] of FIG. 4 is part of a logical qubit of a QEC code having a code distance of three and is party to three entangling gates of the encoding circuit. The structure of the flag gadget 400A corresponding to the data qubit q[0] of FIG. 4 is that the flag gadget includes a single flag qubit, the entanglement point 402A is after the first entangling gate of the encoding circuit to which the corresponding data qubit is a party and before the second entangling gate of the encoding circuit to which the corresponding data qubit is a party, and the disentanglement point 412A is after performance of the last entangling gate to which the corresponding data qubit is a party.

In another example, the data qubit q[6] of FIG. 4 is part of a logical qubit of a QEC code having a code distance of three and is party to two entangling gates of the encoding circuit. The structure of the flag gadget 400B corresponding to the data qubit q[6] of FIG. 4 is that the flag gadget includes a single flag qubit, the entanglement point 402B is before the first entangling gate of the encoding circuit to which the corresponding data qubit is a party, and the disentanglement point 412B is after performance of the last entangling gate to which the corresponding data qubit is a party.

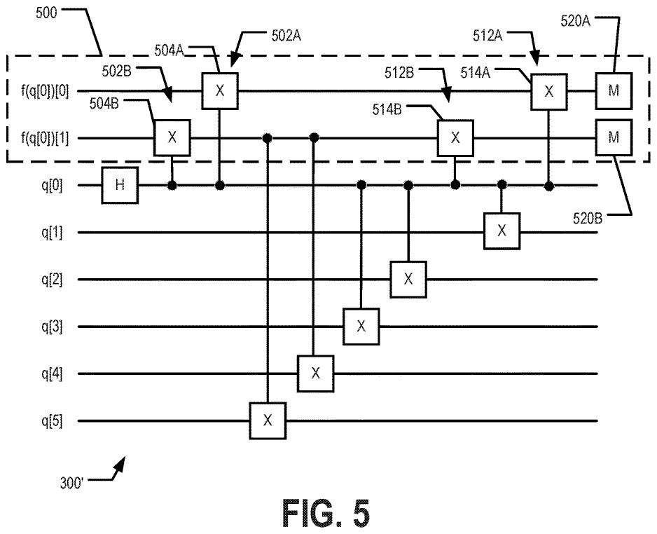

FIG. 5 illustrates an example flag gadget 500 that requires more than one flag qubit to be able to detect errors having a weight that is greater than the tolerance of the QEC code (e.g., any errors of weight larger than d/2 where d is the code distance of the QEC code) and/or errors that may propagate to a higher weight. For an example, the flag gadget 500 is configured to detect errors experienced by the data qubit q[0], when the data qubit q[0] is used to control a plurality of CNOT gates 300′ that target data qubits q[1], q[2], q[3], q[4], q[5] as shown.

Flag gadgets corresponding to the data qubits q[1], q[2], q[3], q[4], q[5] (each corresponding to a code of distance 3 and being party to one entangling gate of the encoding circuit) may each include a single flag qubit, have an entanglement point that is before (e.g., to the left of) the entangling gate to which the corresponding data qubit is a party, and have a disentanglement point that is after (e.g., to the right of) the entangling gate to which the corresponding data qubit is a party. Each of the flag gadgets also include a performing a measurement on the respective flag qubit.

The data qubit q[0] of the logical qubit of the six-qubit stabilizer code corresponds to a code distance of 3 and is party to five entangling gates of the encoding circuit. As a result, a flag gadget that is capable of detecting errors equal to and/or greater than the error tolerance of the QEC code (e.g., d/2) and that only incudes a single qubit does not exist.

FIG. 5 illustrates an example flag gadget 500 corresponding to the data qubit q[0] of the encoding circuit 300′. The flag gadget 500 includes two flag qubits (e.g., f[(q[0])[0] and f(q[0])[1]). For each flag qubit, a respective entanglement point 502 (e.g., 502A, 502B) is defined and a respective disentanglement point 512 (512A, 512B) is defined. The flag gadget 500 also includes a measurement 520 (e.g., 520A, 520B) for each flag qubit.

For example, in time sequenced order, the flag gadget includes performing an entangling gate 504B (e.g., a CNOT gate) with the data qubit q[0] as the control and the flag qubit f(q[0])[1] as the target at a respective entanglement point 512B, performing an entangling gate 504A (e.g., a CNOT gate) with the data qubit q[0] as the control and the flag qubit f(q[0])[0] as the target at a respective entanglement point 512A. As the flag qubit f(q[0])[1] is entangled with the data qubit q[0], the data qubits q[5] and q[4] are entangled with the data qubit q[0] by entangling the data qubits q[5] and q[4] with the flag qubit f(q[0])[1], via respective entangling gates (e.g., CNOT gates), without the possibility of introducing any errors to the data qubit q[0]. The data qubit q[0] is then directly entangled with the data qubits q[3] and q[2] via entangling gates (e.g., CNOT gates). The flag qubit f(q[0])[1] is then disentangled from the data qubit q[0] via a disentangling gate 514B (e.g., a CNOT gate). The final entangling gate of the encoding circuit 300′ is then performed to entangle data qubit q[0] with the data qubit q[1] (with data qubit q[0] as the control of the entangling gate since data qubit q[0] was assigned to the control group and with data qubit q[1] as the target of the entangling gate since data qubit q[1] was assigned to the target group). After performance of the final entangling gate of the encoding circuit 300′, the flag qubit f(q[0])[0] is disentangled from the data qubit q[0] via disentangling gate 514A (e.g., a CNOT gate with the data qubit q[0] as the control and the flag qubit f(q[0])[0] as the target). Measurements 520A, 520B are performed on the flag qubits f(q[0])[0], f(q[0])[1] to complete the flag gadget 500.

As should be understood, the larger the code distance d of the QEC code and/or the larger the number of entangling gates of the encoding circuit to which a data qubit is a party, the more complicated the corresponding flag gadget may become. For example, as the code distance d of the QEC code and/or the number of entangling gates of the encoding circuit to which a data qubit is a party increases, the number of flag qubits in the flag gadget increases.

However, for any data qubits being organized into a logical qubit, the structure of the flag gadget is determined based on the code distance d of the QEC code corresponding to the logical qubit and the number of entangling gates of the encoding circuit to which a data qubit is a party, in various embodiments. For example, the flag gadget for a data qubit of a logical qubit of a [[17, 1, 5]] color code that is party to five entangling gates of the corresponding encoding circuit will be the same as the flag gadget for a data qubit of a logical qubit of a [[25, 1, 5]] rotated surface code that is party to five entangling gates of the corresponding encoding circuit.

In various embodiments, flag gadgets are pre-determined and/or computed and stored. For example, a classical computing entity 110 may store a flag gadget database that includes a plurality of flag gadgets (e.g., information regarding the structure of the flag gadgets) that are indexed by code distance d and number of entangling gates of an encoding circuit to which a corresponding data qubit is a party. When the classical computing entity 110 is preparing a quantum circuit (or at least the logical qubit preparation circuit of a quantum circuit, quantum program, or quantum algorithm) to be provided to a quantum computer 130 for execution, the classical computing entity 110 may determine and insert a flag gadget for each data qubit of the logical qubit into the encoding circuit.

For example, the classical computing entity 110 may receive user input or a request via an application program interface (API) or other interface requesting a fault-tolerant logical qubit preparation circuit for a logical qubit of a particular QEC code. The classical computing entity 110 may determine, identify, and/or access an encoding circuit for the logical qubit where the logical qubit is represented by a bipartite graph. For example, the encoding circuit may include a plurality of entangling gates where each entangling gate is performed using a data qubit of a control group as the control and using a data qubit of a target group as the target (where the control group and the target group have no members in common). The classical computing entity 110, for each data qubit of the logical qubit, determines a number of entangling gates of the encoding circuit to which the data qubit is a party, identifies and/or access a flag gadget from a flag gadget database, for example, that corresponds to the data qubit (e.g., that is indexed by the code distance d of the particular QEC code and the number of entangling gates of the encoding circuit to which the data qubit is a party), and inserts the flag gadget corresponding to the data qubit into the encoding circuit. The classical computing entity 110 may then provide (e.g., transmit) the fault-tolerant logical qubit preparation circuit to a quantum computer 130 (e.g., the controller 132 of the quantum computer) for execution thereof. For example, the fault-tolerant logical qubit preparation circuit may be provided such that the fault-tolerant logical qubit preparation circuit is configured for receipt by a quantum computer 130 (e.g., the controller 132 of the quantum computer 130).

Upon and/or responsive to receipt of the fault-tolerant logical qubit preparation circuit, the quantum computer 130 may execute the fault-tolerant logical qubit preparation circuit to fault-tolerantly prepare a logical qubit of the particular QEC code and/or store the fault-tolerant logical qubit preparation circuit in memory for performance and/or execution at a later time.

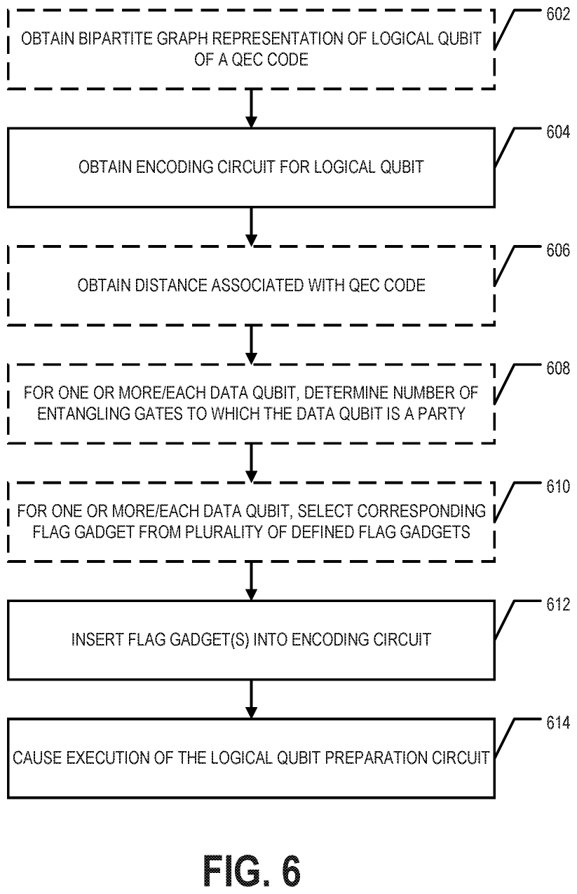

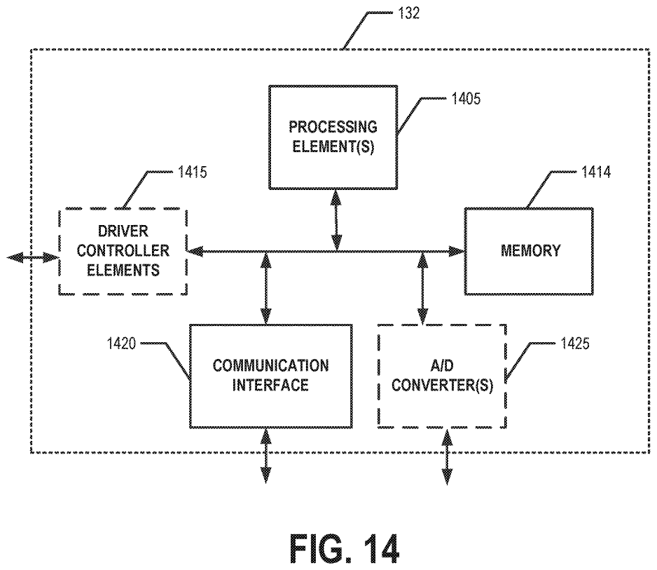

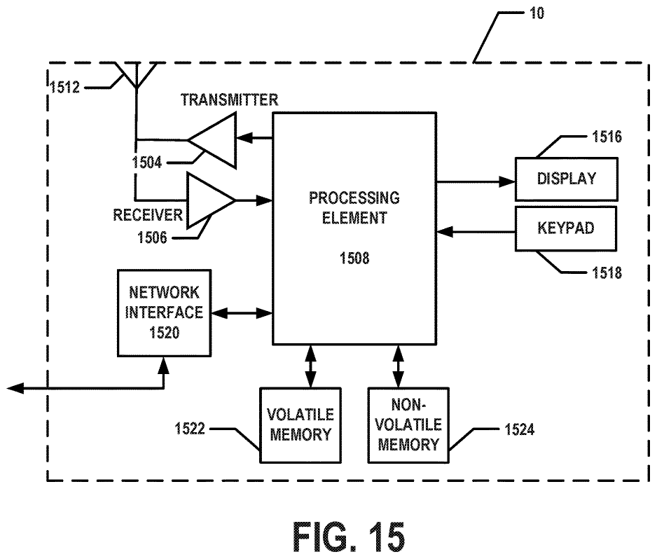

FIG. 6 provides a flowchart illustrating various processes and/or procedures for causing preparation of a logical qubit of a QEC code. In various embodiments, the processes and/or procedures may be performed by a classical computing entity 110 (e.g., by one or more classical processing elements 1508 thereof, see FIG. 15), by a controller 132 of a quantum computer 130 (e.g., by one or more classical processing elements 1405 thereof, see FIG. 14), and/or a combination of the classical computing entity 110 and the controller 132.

Starting at block 602, the classical computing entity 110 or controller 132 obtains a bipartite graph representation of a logical qubit of a QEC code. In various embodiments, obtaining the bipartite graph representation of the logical qubit of the QEC code may include accessing the bipartite graph representation of the logical qubit from a memory, requesting and/or receiving (e.g., via an API call, database query, and/or the like) bipartite graph representation of the logical qubit, receiving user input via a user input/output interface where the user input provides the bipartite graph representation of the logical qubit, accessing and/or receiving a graph representation of the logical qubit (e.g., comprising vertices representing data qubits and edges representing interactions/entanglements between the connected vertices) and processing the graph representation of the logical to generate the bipartite graph representation of the logical qubit, and/or the like.

For example, the classical computing entity 110 may comprise means, such as classical processing elements 1508, classical memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for obtaining the bipartite graph representation of the logical qubit. For example, the controller 132 may comprise means, such as classical processing elements 1405, classical memory 1410, communications interface 1420, and/or the like, for obtaining the bipartite graph representation of the logical qubit.

In various embodiments, a bipartite graph representation of the logical qubit comprises an indication of which data qubits are assigned to and/or are members of the control group, which data qubits are assigned to and/or are members of the target group, and the relationships and/or connections (e.g., the edges) between data qubits of the control group and data qubits of the target group. Notably, there are no direct relationships and/or connections (e.g., edges) between data qubits of the same group. In some embodiments, the QEC code is a CSS QEC code.

At block 604, the classical computing entity 110 or controller 132 obtains an encoding circuit for the logical qubit of the QEC code. In various embodiments, obtaining the encoding circuit for the logical qubit of the QEC code may include accessing the encoding circuit from a memory, requesting and/or receiving (e.g., via an API call, database query, and/or the like) encoding circuit, receiving user input via a user input/output interface where the user input provides the encoding circuit, generating the encoding circuit based at least in part on the bipartite graph representation of the logical qubit, and/or the like.

For example, the classical computing entity 110 may comprise means, such as classical processing elements 1508, classical memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for obtaining the encoding circuit for encoding a plurality of data qubits into the logical qubit. For example, the controller 132 may comprise means, such as classical processing elements 1405, classical memory 1410, communications interface 1420, and/or the like, for obtaining the encoding circuit for encoding a plurality of data qubits into the logical qubit.

In various embodiments, the encoding circuit comprises a plurality of entangling gates on respective pairs of a plurality of data qubits of the logical qubit. Each entangling gate of the plurality of entangling gates is controlled by a control data qubit and targets a target data qubit. The control data qubit is a member of a control group comprising at least one data qubit of the plurality of data qubits and the target data qubit is a member of a target group comprising one or more data qubits of the plurality of data qubits. The control group and the target group are non-overlapping. For example, there are no data qubits that are members of both the control group and the target group. Moreover, each data qubit of the logical qubit a member of exactly one of the control group or the target group. In various embodiments, each entangling gate of the plurality of entangling gates is a controlled two-qubit gate. In various embodiments, the controlled two-qubit gate is a controlled-NOT (CNOT) gate.

At block 606, the classical computing entity 110 or controller 132 obtains a code distance for the QEC code. In various embodiments, obtaining the code distance for the QEC code may include accessing the code distance from a memory, requesting, and/or receiving (e.g., via an API call, database query, and/or the like) the code distance, receiving user input via a user input/output interface where the user input provides the code distance, and/or the like.

For example, the classical computing entity 110 may comprise means, such as classical processing elements 1508, classical memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for obtaining the code distance for the QEC code. For example, the controller 132 may comprise means, such as classical processing elements 1405, classical memory 1410, communications interface 1420, and/or the like, for obtaining the code distance for the QEC code.

At block 608, the classical computing entity 110 or controller 132 determines, for one or more data qubits and/or for each data qubit of the plurality of data qubits of the logical qubit, respective numbers of entangling gates of the encoding circuit to which respective data qubits are a party. For example, the number of entangling gates in the encoding circuit that include a respective data qubit may be counted to determine the number of entangling gates of the encoding circuit to which the respective data qubit is a party. In another example, the number of edges associated with a vertex of a graph representation (e.g., a bipartite graph representation) of the logical qubit, where the vertex corresponds to the respective data qubit, may be counted to determine the number of entangling gates of the encoding circuit to which respective data qubit is a party. In an example embodiment, a user may provide user input via a user input/output interface where the user input indicates a number of entangling gates of the encoding circuit to which the respective data qubit is a party. In another example, the encoding circuit may indicate the number of entangling gates of the encoding circuit to which the respective data qubit is a party.

For example, the classical computing entity 110 may comprise means, such as classical processing elements 1508, classical memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for determining a number of entangling gates of the encoding circuit to which the respective data qubit is a party. For example, the controller 132 may comprise means, such as classical processing elements 1405, classical memory 1410, communications interface 1420, and/or the like, for determining a number of entangling gates of the encoding circuit to which the respective data qubit is a party.

At block 610, the classical computing entity 110 or controller 132 selects, for one or more data qubits and/or for each data qubit of the plurality of data qubits of the logical qubit, a flag gadget data object from a plurality of defined flag gadget data objects. In various embodiments, each flag gadget data object of the plurality of defined flag gadget data objects is associated with and/or indexed by a code distance and a number of entangling gates. The flag gadget data object storing information regarding a flag gadget corresponding to a respective data qubit may be selected by identifying the flag gadget data object associated with and/or indexed by a code distance and number of entangling gates that match and/or are the same as the code distance of the QEC code and the number of entangling gates of the encoding circuit to which the respective data qubit is a party.

For example, a flag gadget database (e.g., stored in classical memory 1522, 1524, 1410, and/or the like) may store a plurality of defined flag gadget data objects that are each associated with a respective code distance and a respective number of entangling gates. The flag gadget database may be queried to identify, determine, and/or select a particular flag gadget data object from the plurality of defined flag gadget data objects that is indexed by and/or associated with a respective code distance that matches and/or is the same as the code distance of the QEC code and that is indexed by and/or associated with a respective number of entangling gates that matches and/or is the same as the number of entangling gates of the encoding circuit to which the respective data qubit is a party.

For example, the classical computing entity 110 may comprise means, such as classical processing elements 1508, classical memory 1522, 1524, communications interfaces (e.g., a radio interface including receiver 1506, transmitter 1504, and antenna 1512 and/or network interface 1520), and/or the like, for selecting respective flag gadget data objects corresponding to respective data qubits of the logical qubit. For example, the controller 132 may comprise means, such as classical processing elements 1405, classical memory 1410, communications interface 1420, and/or the like, for selecting respective flag gadget data objects corresponding to respective data qubits of the logical qubit.

At block 612, the classical computing entity 110 or controller 132 inserts, for one or more data qubits and/or for each data qubit of the plurality of data qubits of the logical qubit, a corresponding flag gadget based on a corresponding selected flag gadget data object. In various embodiments, each flag gadget data object indicates a structure of the corresponding flag gadget. The structure of a flag gadget comprises a number of flag qubits of the flag gadget, respective entanglement points for each flag qubit of the flag gadget, respective disentanglement points for each flag qubit of the flag gadget, any entangling gates of the encoding circuit to be performed using a respective flag qubit of the flag gadget (e.g., any entangling gates similar to where flag qubit f(q[0])[1] was used to control the entangling gates targeting data qubits q[5] and q[4] in FIG. 5), and/or any other information required to implement the flag gadget. For example, a flag gadget data object comprises indications of a number of flag qubits of the flag gadget, respective entanglement points for each flag qubit of the flag gadget, respective disentanglement points for each flag qubit of the flag gadget, any entangling gates of the encoding circuit to be performed using a respective flag qubit of the flag gadget (e.g., any entangling gates similar to where flag qubit f(q[0])[1] was used to control the entangling gates targeting data qubits q[5] and q[4] in FIG. 5), and/or any other information required to implement the flag gadget.

The respective flag gadgets corresponding to one or more data qubits and/or each of the data qubits of the plurality of data qubits of the logical qubit are inserted into the encoding circuit in accordance with the flag gadget structure indicated by the corresponding flag gadget data object. For example, the entanglement gates between respective flag qubits and the corresponding data qubit may be inserted into the encoding circuit at the respective entanglement points, the disentanglement gates between respective flag qubits and the corresponding data qubit may be inserted into the encoding circuit at the respective disentanglement points, measurements of the flag qubits may be inserted into the encoding circuit (after the respective disentanglement point), and any entangling gates of the encoding circuit to be performed using a flag qubit may be modified accordingly (in accordance with the information stored in the flag gadget data object), to insert the flag gadget into the encoding circuit. Insertion of the one or more flag gadgets into the encoding circuit forms and/or generates the logical qubit preparation circuit.

For example, the classical computing entity 110 may comprise means, such as classical processing elements 1508, classical memory 1522, 1524, and/or the like, for inserting one or more flag gadgets into the encoding circuit to form and/or generate the logical qubit preparation circuit. For example, the controller 132 may comprise means, such as classical processing elements 1405, classical memory 1410, and/or the like, for inserting one or more flag gadgets into the encoding circuit to form and/or generate the logical qubit preparation circuit.

At block 614, the classical computing entity 110 or controller 132 causes the quantum computer to execute the logical qubit preparation circuit to (fault-tolerantly) prepare the logical qubit of the QEC code. For example, the classical computing entity 110 may provide (e.g., transmit) the logical qubit preparation circuit for receipt by a quantum computer 130 (e.g., the controller 132 of the quantum computer) for execution thereof. For example, classical computing entity 110 may provide the logical qubit preparation circuit such that the logical qubit preparation circuit is configured for receipt by a quantum computer 130 (e.g., the controller 132 of the quantum computer 130). Upon and/or responsive to receipt of the logical qubit preparation circuit, the quantum computer 130 may execute the fault-tolerant logical qubit preparation circuit to (fault-tolerantly) prepare a logical qubit of the QEC code and/or store the logical qubit preparation circuit in memory for performance and/or execution at a later time.

In another example, responsive to forming and/or generating the logical qubit preparation circuit, the controller 132 may control operation of the qubit manipulation elements 136 and/or sensors 138 to cause execution of the logical qubit preparation circuit such that a logical qubit is prepared (in a fault-tolerant manner). In some embodiments, the controller 132 may store the logical qubit preparation circuit in memory (e.g., classical memory 1410) for execution at a later time (e.g., possibly in response to receiving a request from the classical computing entity 110 for performing a quantum circuit).

For example, the classical computing entity 110 may comprise means, such as classical processing elements 1508, classical memory 1522, 1524, communications interfaces (e.g., a radio interface including receiver 1506, transmitter 1504, and antenna 1512 and/or network interface 1520), and/or the like, for causing a quantum computer to execute the logical qubit preparation circuit. For example, the controller 132 may comprise means, such as classical processing elements 1405, classical memory 1410, driver controller elements 1415, communication interface 1420, and/or the like, for causing the quantum computer 130 to execute the logical qubit preparation circuit.

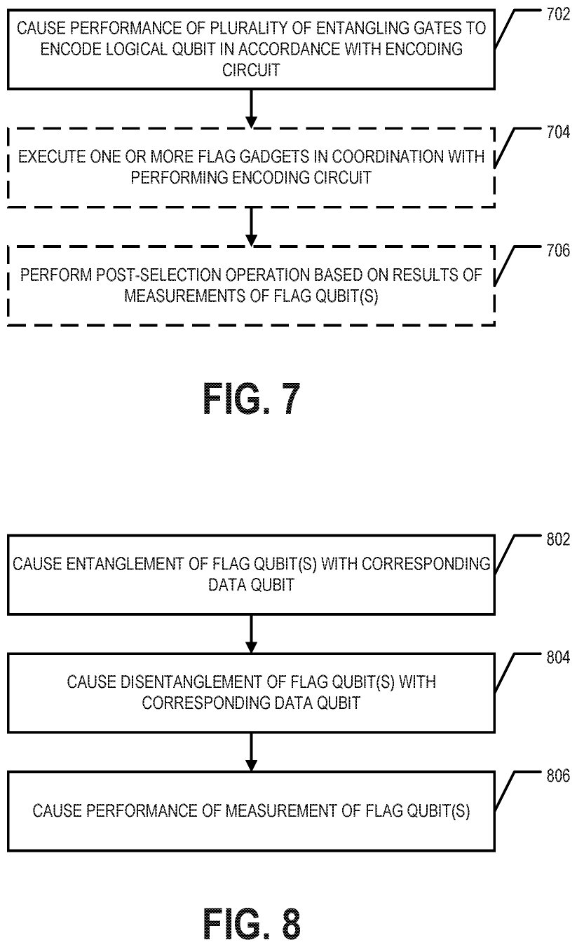

FIG. 7 provides a flowchart illustrating various processes and/or procedures performed by a controller 132 of a quantum computer 130 for executing a logical qubit preparation circuit to (fault-tolerantly) prepare a logical qubit of a QEC code.

Starting at block 702, the controller 132 causes performance of a plurality of entangling gates to encode a logical qubit of the QEC code in accordance with an encoding circuit. For example, the controller 132 comprises means, such as classical processing elements 1405, classical memory 1410, driver controller elements 1415, and/or the like, for controlling operation of qubit manipulation elements 136 to cause the qubit manipulation elements 136 to perform a plurality of entangling gates a plurality of data qubits to logically organize and/or entangle the plurality of data qubits into the logical qubit. The plurality of data qubits are a subset of the plurality of physical qubits 134. The plurality of entangling gates are performed in accordance with the encoding circuit of the logical qubit preparation circuit. The plurality of entangling gates are performed on respective pairs of a plurality of data qubits being logically organized and/or entangled into the logical qubit. Each entangling gate of the plurality of entangling gates is controlled by a control data qubit and targets a target data qubit. The control data qubit is a member of a control group that includes at least one data qubit of the plurality of data qubits and the target data qubit is a member of a target group that includes one or more data qubits of the plurality of data qubits. The control group and the target group are non-overlapping.

At block 704, the controller 132 may execute one or more flag gadgets of the logical qubit preparation circuit in coordination with performing the encoding circuit. For example, the controller 132 comprises means, such as classical processing elements 1405, classical memory 1410, driver controller elements 1415, A/D converters 1425, and/or the like, for controlling operation of qubit manipulation elements 136 and/or sensors 138 to cause execution of one or more flag gadgets of the logical qubit preparation circuit in coordination with the performing the plurality of entangling gates of the encoding circuit.

For example, the logical qubit preparation circuit may indicate that respective entangling gates of the one or more flag gadgets be performed before and/or during performance of the plurality of entangling gates of the encoding circuit (e.g., at their respective entanglement points) and that respective disentangling gates of the one or more flag gadgets be performed during and/or after performance of the plurality of entangling gates of the encoding circuit (e.g., at their respective disentanglement points). The logical qubit preparation circuit may further indicate that measurements of the flag qubits should be performed after their respective disentanglement points. The controller 132 controls operation of the qubit manipulation elements 136 and/or sensors 138 to cause the entangling gates of the flag gadgets to be performed at their respective entanglement points, to cause the disentangling gates of the flag gadgets to be performed at their respective disentanglement points, and to cause the flag qubit measurements to be performed after their respective disentanglement points.

At block 706, the controller 132 performs a post-selection operation based on the results of the measurements of the flag qubits of the one or more flag gadgets. For example, the controller 132 comprises means, such as classical processing elements 1405, classical memory 1410, and/or the like, for performing a post-selection operation based on the results of the measurement of the flag qubits of the one or more flag gadgets. For example, performing the flag qubit measurements of the one or more flag gadgets causes the controller 132 to obtain and/or determine results of the measurements of the flag qubits and/or results of the flag gadgets. The controller 132 may process the results of the measurements of the flag qubits and/or results of the flag gadgets to determine errors larger than a tolerance of the QEC code were detected.

For example, the controller 132 may process the measurements of the flag qubits and/or results of the flag gadgets to determine a highest weight of error detected, a number of errors detected, and/or other error information. The controller 132 evaluates one or more error threshold criteria based at least in part on one or more of the highest weight of error detected, number of errors detected, possibility of a detected error propagating, and/or other error information. In an example embodiment, the one or more error threshold criteria may be determined and/or corresponding to an error tolerance of the QEC code. For example, the error tolerance of the QEC code is FLOOR(d/2), where d is the distance of the code. For example, if the QEC code has a code distance of five, then the QEC code has an error tolerance of two.

Responsive to determining that the number of errors detected, the highest weight of error detected, the possibility of detected errors propagating, and/or an aggregation thereof (e.g., a weighted sum where each error detected is weighted by the weight of that error) does not satisfy the one or more error threshold criteria (e.g., the number of errors detected, the highest weight of error detected, and/or an aggregation thereof is equal to and/or greater than the error tolerance of the QEC code), the controller 132 determines that the preparation of the logical qubit failed. Responsive to determining that the preparation of the logical qubit failed, the controller 132 may reinitialize each of the plurality of data qubits (and the flag qubits) and perform the logical qubit preparation circuit again.

Responsive to determining that the number of errors detected, the highest weight of error detected, possibility of detected errors propagating, and/or an aggregation thereof (e.g., a weighted sum where each error detected is weighted by the weight of that error) satisfies the one or more error threshold criteria (e.g., the number of errors detected, the highest weight of error detected, and/or an aggregation thereof is equal to and/or less than the error tolerance of the QEC code), the controller 132 determines that the preparation of the logical qubit was successful (e.g., the logical qubit was fault-tolerantly prepared). Responsive to determining that the preparation of the logical qubit was successful, the controller 132 may perform quantum computations, a quantum algorithm, and/or the like using the prepared logical qubit.

FIG. 8 provides a flowchart illustrating various processes and/or procedures performed by a controller 132 of a quantum computer 130 for executing a flag gadget.

Starting at block 802, the controller 132 causes entanglement of each flag qubit of the flag gadget with the corresponding data qubit at a respective entanglement point. For example, the controller 132 comprises means, such as classical processing elements 1405, classical memory 1410, driver controller elements 1415, A/D converters 1425, and/or the like, for controlling operation of the qubit manipulation elements 136 and/or sensors 138 to cause entanglement of each flag qubit of the flag gadget with the corresponding data qubit at a respective entanglement point. For example, each flag qubit is a target of an entangling gate (e.g., a controlled entangling gate such as a CNOT gate) with the corresponding data qubit as the control (or possibly another flag qubit that is already entangled with the data qubit) at a point in the encoding circuit indicated by the respective entanglement point.

At block 804, the controller 132 causes disentanglement of each flag qubit of the flag gadget with the corresponding data qubit at a respective disentanglement point. For example, the controller 132 comprises means, such as classical processing elements 1405, classical memory 1410, driver controller elements 1415, A/D converters 1425, and/or the like, for controlling operation of the qubit manipulation elements 136 and/or sensors 138 to cause disentanglement of each flag qubit of the flag gadget with the corresponding data qubit at a respective disentanglement point. For example, each flag qubit is a target of a disentangling gate (e.g., a controlled entangling gate such as a CNOT gate) with the corresponding data qubit as the control at a point in the encoding circuit indicated by the respective disentanglement point.

At block 806, the controller 132 causes performance of measurements of the flag qubits after their respective disentanglement points. For example, the controller 132 comprises means, such as classical processing elements 1405, classical memory 1410, driver controller elements 1415, A/D converters 1425, and/or the like, for controlling operation of the qubit manipulation elements 136 and/or sensors 138 to cause measurement operations to be performed on each flag qubit of a flag gadget. The results of the measurement operations provides an indication of a number of errors detected by the flag gadget, the weight of any errors detected by the flag gadget, a type of error detected by the flag gadget, and/or the like.

Example Flag Gadget Data Object Generation and/or Bounding a Number of Flag Qubits of a Flag Gadget

Various embodiments provide methods, apparatuses, systems, computer program products, and/or the like for generating flag gadget data objects and/or for bounding the number of flag qubits in a flag gadget. For example, an error propagation model may be used to identify and/or generate flag gadgets (e.g., identify and/or determine respective entanglement points and respective disentanglement points) comprising a number of flag qubits that is configured to detect errors of a weight greater than the tolerance of a QEC code and/or errors that may propagate to a higher weight. The error propagation model may be iteratively executed with the number of flag qubits being reduced (e.g., by one) at each iteration until a flag gadget having the number of flag qubits cannot be identified. The flag gadget generated at the previous iteration (e.g., the final successful iteration) may be used to generate a flag gadget data object that stores information indicating the structure of the data object and/or may indicate the minimal upper bound of the number of flag qubits needed for a flag gadget to detect any errors of a weight greater than a tolerance corresponding to a code distance and/or errors that may propagate to a higher weight than their original weight.

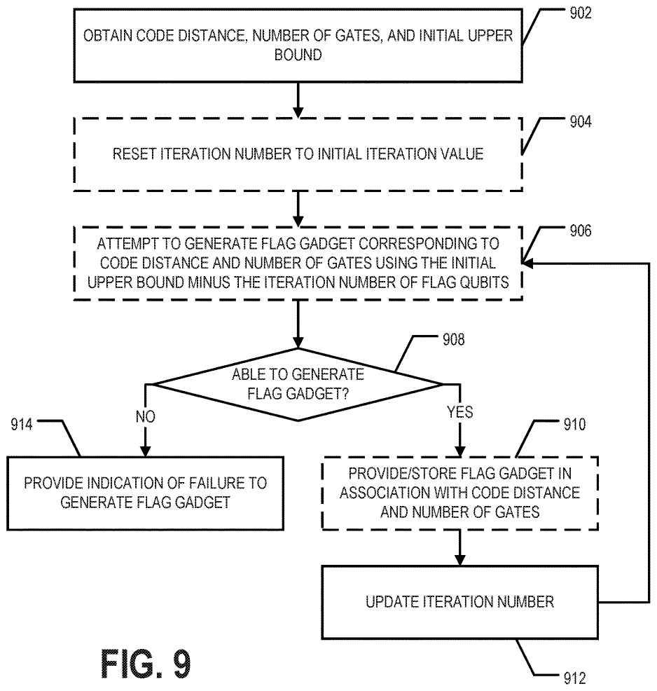

FIG. 9 provides a flowchart of various processes and/or operations that may be performed by a classical computing entity 110, for example, to generate a flag gadget data object for a code distance and number of gates and/or to determine a minimal upper bound for the number of flag qubits required for a flag gadget corresponding to a code distance and number of gates to detect errors of a weight greater than the tolerance of the QEC code and/or errors that may propagate to a higher weight than their original weight.

Staring at block 902, the classical computing entity 110 obtains a code distance, number of gates, and an initial upper bound. For example, the classical computing entity 110 may comprise means, such as processing element 1508, memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for obtaining a code distance, number of gates, and an initial upper bound. The code distance defines the tolerance of the QEC code. The number of gates indicates the number of opportunities for an error to occur. The initial upper bound indicates the initial number of flag qubits to be tested.

In various embodiments, obtaining the code distance, number of gates, and initial upper bound may include one or more of accessing the code distance, number of gates, and/or initial upper bound from a memory, requesting and/or receiving (e.g., via an API call, database query, and/or the like) the code distance, number of gates, and/or initial upper bound, receiving user input via a user input/output interface where the user input provides the code distance, number of gates, and/or initial upper bound, and/or the like.

At block 904, the classical computing entity 110 resets the iteration number to an initial iteration value. In various embodiments, the initial iteration value is 0. For example, the classical computing entity 110 comprises means, such as processing element 1508, memory 1522, 1524, and/or the like, for resting the iteration number to an initial iteration value.

The classical computing entity 110 may then perform one or more iterations of blocks 906 through 912. For example, the classical computing entity 110 may iteratively perform blocks 906 through 912 until reaching block 914.

At block 906, an error propagation model is executed to determine whether the error propagation model is able to identify, determine, and/or generate a flag gadget comprising a number of flag qubits equal to the initial upper bound minus the iteration number that is capable of detecting and/or identifying errors of a weight greater than a tolerance corresponding to the code distance and/or errors that may propagate to a higher weight. For example, the error propagation model may test whether, for each entangling gate of the number of gates, a corresponding data qubit experienced an error during and/or as a result of that entangling gate, would the flag qubit be able to detect the error. For example, the classical computing entity 110 may comprise means, such as processing element 1508, memory 1522, 1524, and/or the like, for attempting to generate a flag gadget corresponding to the code distance and number of gates using a number of flag qubits equal to the initial upper bound minus the iteration number of flag qubits using an error propagation model.

At block 908, the classical computing entity 110 determines whether a flag gadget was determined, identified, and/or generated that, for the number of gates and a number of flag qubits equal to the initial upper bound minus the iteration number, is capable of detecting and/or identifying errors of a weight greater than a tolerance corresponding to the code distance and/or errors that may propagate to a higher weight than their original weight. For example, the classical computing entity 110 may comprise means, such as processing element 1508, memory 1522, 1524, and/or the like, for determining whether a flag gadget was determined, identified, and/or generated that, for the number of gates and a number of flag qubits equal to the initial upper bound minus the iteration number, is capable of detecting and/or identifying errors of a weight greater than a tolerance corresponding to the code distance and/or errors that may propagate to a higher weight than their original weight.

Responsive to determining that a flag gadget was determined, identified, and/or generated that, for the number of gates and a number of flag qubits equal to the initial upper bound minus the iteration number, is capable of detecting and/or identifying errors of a weight greater than a tolerance corresponding to the code distance and/or errors that may propagate to a higher weight than their original weight, the process continues to block 910. At block 910, that classical computing entity 110 generates and/or stores (e.g., in memory 1522, 1524) a flag gadget data object that comprises information indicating the structure of the flag gadget and that includes and/or is associated with the code distance, the number of gates, and the number of flag qubits in the flag gadget (e.g., the initial upper bound minus the iteration number). For example, the classical computing entity 110 may comprise means, such as processing element 1508, memory 1522, 1524, and/or the like, for generating and/or storing (e.g., in memory 1522, 1524) a flag gadget data object that comprises information indicating the structure of the flag gadget and that includes and/or is associated with the code distance, the number of gates, and the number of flag qubits in the flag gadget (e.g., the initial upper bound minus the iteration number). For example, a flag gadget data object comprises indications of a number of flag qubits of the flag gadget, respective entanglement points for each flag qubit of the flag gadget and respective disentanglement points for each flag qubit of the flag gadget.

At block 912, the classical computing entity 110 updates the iteration number. For example, the classical computing entity 110 comprises means, such as processing element 1508, memory 1522, 1524, and/or the like, for updating the iteration number. In various embodiments, the iteration number is updated by adding one to the current iteration number (e.g., iteration number=iteration number+1).

The process then returns to block 906 and the classical computing entity 110 attempts determine, identify, and/or generate, based at least in part on the error propagation model whether a flag gadget comprising a number of flag qubits equal to the initial upper bound minus the (updated) iteration number and that is capable of detecting and/or identifying errors of a weight greater than a tolerance corresponding to the code distance and/or errors that may propagate to a higher weight than their original weight.

Responsive to determining that a flag gadget was not determined, identified, and/or generated that, for the number of gates and a number of flag qubits equal to the initial upper bound minus the iteration number, is capable of detecting and/or identifying errors of a weight greater than a tolerance corresponding to the code distance and/or errors that may propagate to a higher weight than their original weight, the process continues to block 914.

At block 914, the classical computing entity 110 stops the iterative performance of blocks 906-912 and provides an indication of the failure to generate a flag gadget. For example, the classical computing entity 110 comprises means, such as processing element 1508, memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for provides an indication of the failure to generate a flag gadget.

In some embodiments, the indication of the failure to generate the flag gadget may include storing and/or causing display (e.g., via display 1516) an indication of the minimal upper bound. For example, the value of the initial upper bound minus the iteration number for the last iteration that successfully identified a flag gadget may be set to the minimal upper bound. The minimal upper bound is the smallest identified upper bound on the number for flag qubits required for a successful flag gadget corresponding to the code distance and the gate number.

In some embodiments, a flag gadget data object is generated, stored, and/or added to a flag gadget database based on the last successful iteration of block 906-912. For example, the flag gadget data object generated on the final performance of block 910 may be added to a flag gadget database comprising a plurality of defined flag gadgets.

### Example Logical Qubit Preparation Using Cat States

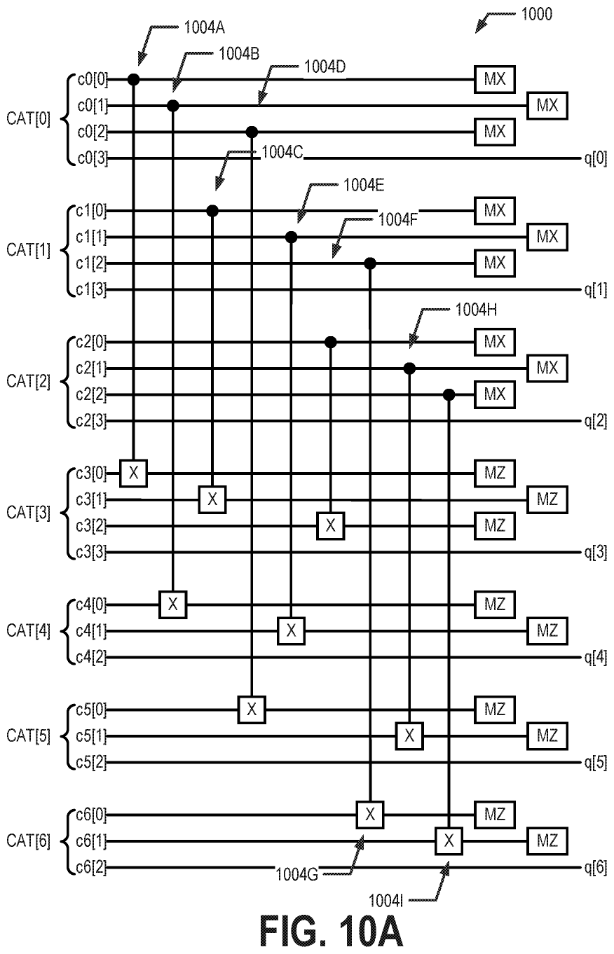

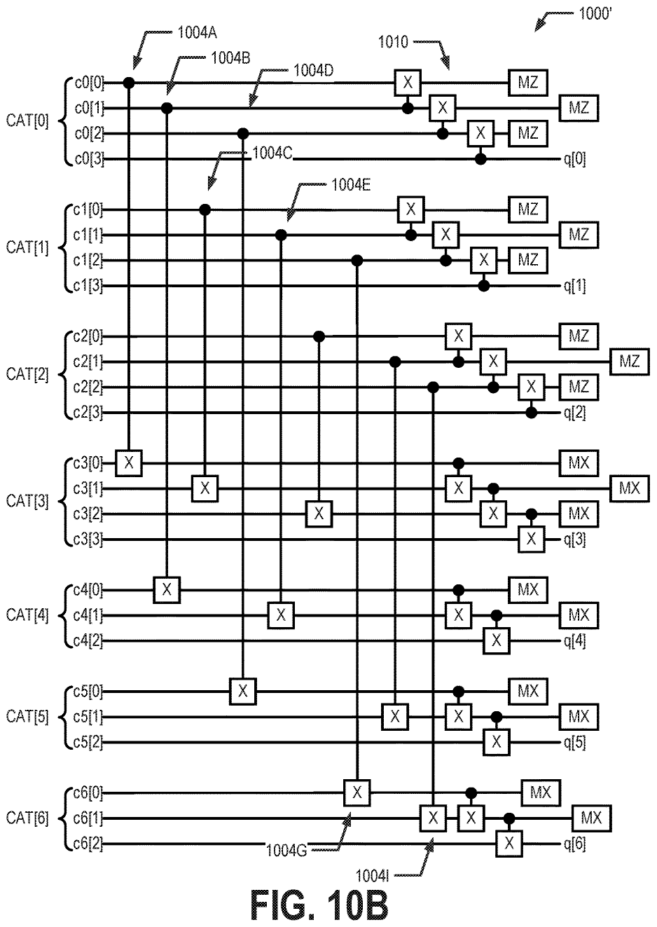

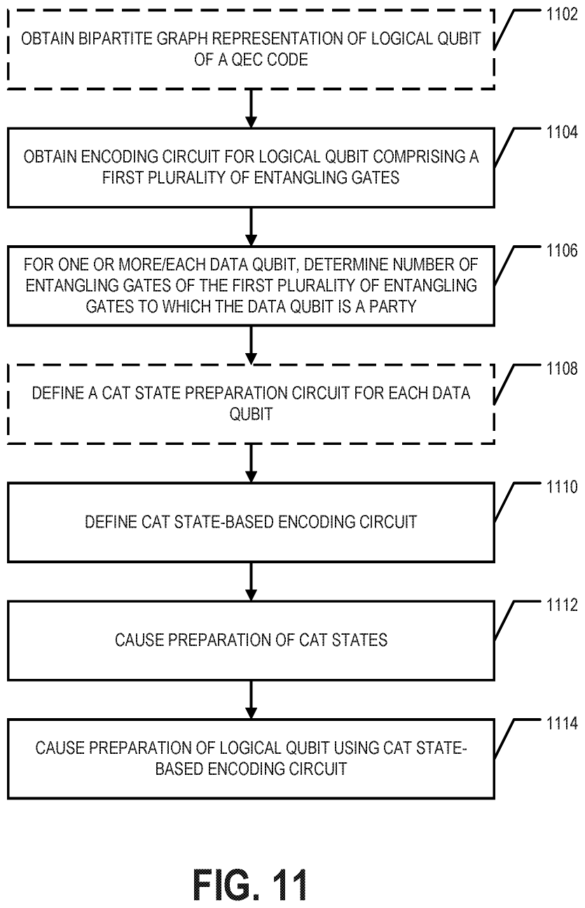

FIG. 10A provides an example cat state-based encoding circuit 1000 that may be used to fault tolerantly encode a logical qubit 200 as a bi-partite graph. As should be understood, cat state-based encoding circuits may be generated and performed for various logical qubits in addition to the Steane code logical qubit 200, as described with respect to FIG. 11.

For each data qubit of the logical qubit 200, a corresponding cat state CAT[i] is prepared. A cat state is a multi-object quantum state where a plurality of physical qubits are entangled with one another in a superposition of two macroscopically distinct or distinguishable states. In certain embodiments, the cat states are respective Greenberger-Horne-Zeilinger states (GHZ states). The cat states may be prepared fault tolerantly using, for example, flag gadgets. Post-selection may be used to proceed with cat states that were fault tolerantly prepared. For example, the cat state-based encoding circuit 1000 may only be performed with cat states that were determined to have been performed without any errors occurring (e.g., the results of performing measurement operations on all of the flag qubits of the flag gadgets used to perform the preparation of the cat state are equal to and/or match an expected value).

In various embodiments, the cat states corresponding to data qubits of the logical qubit that are members of the control group (e.g., cat states corresponding to control data where N+1, the cat state

$$\frac{1}{\sqrt{2}} ( \vert 0 {\text{?}}^{N + 1} + \vert 1 {\text{?}}^{N + 1} ) ,$$

where N+1, the cat state size is the number of physical qubits in the cat state. For example, when the cat state size N+1=3,

$$\frac{1}{\sqrt{2}} ( \vert 0 {\text{?}}^{N + 1} + \vert 1 {\text{?}}^{N + 1} ) = \frac{1}{\sqrt{2}} ( \vert 111 \text{?} + \vert 000 \text{?} ) .$$

The cat states corresponding to data qubits of the logical qubit that are members of the target group (e.g., cat states corresponding to target data qubits) are prepared in the cat state

$$\frac{1}{\sqrt{2}} ( \vert + {\text{?}}^{N + 1} + \vert - {\text{?}}^{N + 1} ) .$$

Each cat state includes a respective number of physical qubits corresponding to the cat state size N+1 where the cat state size N+1 corresponds to a number of physical qubits that is equal to the number of entangling gates N that the corresponding data qubit is a party to in the encoding circuit 300 plus one. For example, the first data qubit q[0] in the encoding circuit 300 is party to three entangling gates 304A, 304B, and 304D (e.g., N=3). The cat state CAT[0] illustrated in FIG. 10A that corresponds to the first data qubit q[0] of the encoding circuit 300 includes 3+1=4 physical qubits c0[0], c0[1], c0[2], c0[3] and therefore has a cat state size of N+1=4.

In various embodiments, the cat state-based encoding circuit 1000 includes entangling gates 1004A-1004I which correspond to the entangling gates 304A-304I of the encoding circuit 300. Each physical qubit of the cat states CAT[0]-CAT[6] is party to at most one entangling gate 1004A-1004I. This means the entangling gates 1004A-1004I may be performed in a single circuit layer and/or as a depth one action. In other words all of the entangling gates 1004A-1004I may be performed in parallel and/or at least partially overlapping in time. Each cat state CAT[i] includes one physical qubit that is not party to any of the entangling gates 1004A-1004I. This physical qubit is the corresponding data qubit q[i] of the resulting logical qubit 200.

After performance of the plurality of entangling gates 1004A-1004I, a qubit measurement operation is performed on at least one of the respective plurality of physical qubits of each cat state CAT[0]-CAT[6]. For example, a qubit measurement operation is performed on each physical qubit of a cat state that was party to an entangling gate 1004A-1004I. Qubit measurement operations are not performed on the physical qubits of the cat states that are to be the data qubits of the logical qubit.

In various embodiments, the physical qubits of the cat states corresponding to data qubits of the logical qubit that are members of the control group (e.g., cat states corresponding to control data qubits) are measured in the X-basis, as indicated by the MX boxes on the corresponding qubit wires in FIG. 10A. The physical qubits of the cat states corresponding to data qubits of the logical qubit that are members of the target group (e.g., cat states corresponding to target data qubits) are measured in the Z-basis, as indicated by the MZ boxes on the corresponding qubit wires in FIG. 10A.

Based on the results of performing the measurement operations on the physical qubits that were party to entangling gates 1004A-1004I, the controller 132 can confirm whether the entangling gates 1004A-1004I were performed without the occurrence of errors or whether an error occurred during performance of the entangling gates 1004A-1004I and a correction should be applied to one or more data qubits of the logical qubit. For example, a parity of the results of the measurement operations performed on the physical qubits c0[0], c0[1], c0[2] of the cat state CAT[0] may be used to determine whether a correction (e.g., a bit-flip correction and/or the like) should be performed on the corresponding data qubit q[0]. For example, responsive to determining that the parity of the results of the measurement operations performed on the physical qubits c0[0], c0[1], c0[2] of the cat state CAT[0] is odd, a correction may be applied to the corresponding data qubit q[0]. After performance of any corrections deemed necessary based on the processing of the results of the measurement operations, the logical qubit 200 has been fault tolerantly encoded in the logical |0> state and may be used to perform various quantum computations.

FIG. 10B provides another cat state-based encoding circuit 1000′ that is similar to the cat state-based encoding circuit 1000. In the cat state-based encoding circuit 1000′, after performance of the plurality of entangling gates 1004A-1004I, for each cat state CAT [i], a disentangling ladder 1010 is performed to disentangle the physical qubits of the cat state from one another. For example, after performance of the entangling gates 1004A-1004I, a disentangling gate (e.g., a CNOT gate) is performed on physical qubit c0[1] of cat state CAT[0] that is control by physical qubit c0[0] of cat state CAT[0], followed by a disentangling gate (e.g., a CNOT gate) performed on physical qubit c0[2] of cat state CAT[0] that is control by physical qubit c0[1] of cat state CAT[0], which is in turn followed by a disentangling gate (e.g., a CNOT gate) performed on physical qubit c0[3] of cat state CAT[0] (which is data qubit q[0] of the logical qubit 200) that is control by physical qubit c0[2] of cat state CAT[0]. This disentangling ladder 1010 disentangles the data qubit q[0] from the remainder of the physical qubits c0[0], c0[1], c0[2] of the cat state CAT[0]. Similar disentangling ladders may be performed on the other cat states to disentangle the respective data qubits q[1]-[q[6]. The physical qubits of the cat states corresponding to data qubits of the logical qubit that are members of the control group (e.g., cat states corresponding to control data qubits) are then measured in the Z-basis, as indicated by the MZ boxes on the corresponding qubit wires in FIG. 10B. The physical qubits of the cat states corresponding to data qubits of the logical qubit that are members of the target group (e.g., cat states corresponding to target data qubits) are measured in the X-basis, as indicated by the MX boxes on the corresponding qubit wires in FIG. 10B. The results of the measurement operations performed on the physical qubits of a given cat state may be used to determine whether to perform a correction on the corresponding data qubit of the given cat state.

FIG. 11 provides a flowchart illustrating various processes and/or procedures for causing preparation of a logical qubit of a QEC code using a cat-state based encoding circuit. In various embodiments, the processes and/or procedures may be performed by a classical computing entity 110 (e.g., by one or more classical processing elements 1508 thereof, see FIG. 15), by a controller 132 of a quantum computer 130 (e.g., by one or more classical processing elements 1405 thereof, see FIG. 14), and/or a combination of the classical computing entity 110 and the controller 132.

Starting at block 1102, the classical computing entity 110 or controller 132 obtains a bipartite graph representation of a logical qubit of a QEC code. In various embodiments, obtaining the bipartite graph representation of the logical qubit of the QEC code may include accessing the bipartite graph representation of the logical qubit from a memory, requesting and/or receiving (e.g., via an API call, database query, and/or the like) bipartite graph representation of the logical qubit, receiving user input via a user input/output interface where the user input provides the bipartite graph representation of the logical qubit, accessing and/or receiving a graph representation of the logical qubit (e.g., comprising vertices representing data qubits and edges representing interactions/entanglements between the connected vertices) and processing the graph representation of the logical to generate the bipartite graph representation of the logical qubit, and/or the like.

For example, the classical computing entity 110 may comprise means, such as classical processing elements 1508, classical memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for obtaining the bipartite graph representation of the logical qubit. For example, the controller 132 may comprise means, such as classical processing elements 1405, classical memory 1410, communications interface 1420, and/or the like, for obtaining the bipartite graph representation of the logical qubit.

In various embodiments, a bipartite graph representation of the logical qubit comprises an indication of which data qubits are assigned to and/or are members of the control group, which data qubits are assigned to and/or are members of the target group, and the relationships and/or connections (e.g., the edges) between data qubits of the control group and data qubits of the target group. Notably, there are no direct relationships and/or connections (e.g., edges) between data qubits of the same group. In some embodiments, the QEC code is a CSS QEC code.

At block 1104, the classical computing entity 110 or controller 132 obtains an encoding circuit for the logical qubit of the QEC code. In various embodiments, obtaining the encoding circuit for the logical qubit of the QEC code may include accessing the encoding circuit from a memory, requesting and/or receiving (e.g., via an API call, database query, and/or the like) encoding circuit, receiving user input via a user input/output interface where the user input provides the encoding circuit, generating the encoding circuit based at least in part on the bipartite graph representation of the logical qubit, and/or the like.

For example, the classical computing entity 110 may comprise means, such as classical processing elements 1508, classical memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for obtaining the encoding circuit for encoding a plurality of data qubits into the logical qubit. For example, the controller 132 may comprise means, such as classical processing elements 1405, classical memory 1410, communications interface 1420, and/or the like, for obtaining the encoding circuit for encoding a plurality of data qubits into the logical qubit.

In various embodiments, the encoding circuit comprises a first plurality of entangling gates on respective pairs of a plurality of data qubits of the logical qubit. Each entangling gate of the first plurality of entangling gates is controlled by a control data qubit and targets a target data qubit. The control data qubit is a member of a control group comprising at least one data qubit of the plurality of data qubits and the target data qubit is a member of a target group comprising one or more data qubits of the plurality of data qubits. The control group and the target group are non-overlapping. For example, there are no data qubits that are members of both the control group and the target group. Moreover, each data qubit of the logical qubit a member of exactly one of the control group or the target group. In various embodiments, each entangling gate of the first plurality of entangling gates is a controlled two-qubit gate. In various embodiments, the controlled two-qubit gate is a controlled-NOT (CNOT) gate.

At block 1106, the classical computing entity 110 or controller 132 determines, for one or more data qubits and/or for each data qubit of the plurality of data qubits of the logical qubit, respective numbers of entangling gates Nᵢ of the first plurality of entangling gates to which respective data qubits are a party. For example, the number of entangling gates of the first plurality of entangling gates that include a respective data qubit may be counted to determine the number of entangling gates of the first plurality of entangling gates to which the respective data qubit is a party. In another example, the number of edges associated with a vertex of a graph representation (e.g., a bipartite graph representation) of the logical qubit, where the vertex corresponds to the respective data qubit, may be counted to determine the number of entangling gates of the first plurality of entangling gates to which respective data qubit is a party. In an example embodiment, a user may provide user input via a user input/output interface where the user input indicates a number of entangling gates of the first plurality of entangling gates to which the respective data qubit is a party. In another example, the encoding circuit may indicate the number of entangling gates of the first plurality of entangling gates to which the respective data qubit is a party.

For example, the classical computing entity 110 may comprise means, such as classical processing elements 1508, classical memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for determining a number of entangling gates of the first plurality of entangling gates to which the respective data qubit is a party. For example, the controller 132 may comprise means, such as classical processing elements 1405, classical memory 1410, communications interface 1420, and/or the like, for determining a number of entangling gates of the first plurality of entangling gates to which the respective data qubit is a party.

At block 1108, the classical computing entity 110 or controller 132 defines a respective cat state preparation circuit corresponding to each data qubit of the logical qubit. For example, the cat state CAT[i] corresponding to a data qubit q[i] of the logical qubit of the QEC code is defined to have a cat state size Nᵢ+1 (i.e., to include Nᵢ+1 physical qubits) where the cat state size Nᵢ+1 is equal to one plus the number of entangling gates Nᵢ of the first plurality of entangling gates to which the corresponding data qubit q[i] is a party. For example, using the example of the encoding circuit 300, data qubit q[0] is party to three entangling gates of the first plurality of entangling gates of the encoding circuit 300 (N₀=3), so the cat state corresponding to data qubit q[0] includes four physical qubits (i.e., has a cat state size N₀+1=4) and the data qubit q[6] is party to two entangling gates of the first plurality of entangling gates of the encoding circuit 300 (e.g., N₆=2), so the cat state corresponding to data qubit q[6] includes three physical qubits (i.e., has a cat state size N₆+1=3). Each cat state CAT[i] corresponding to a control data qubit q[i] is prepared into the cat state

$$\frac{1}{\sqrt{2}} ( \vert 0 {\text{?}}^{{N}_{i} + 1} + \vert 1 {\text{?}}^{{N}_{i} + 1} ) ,$$

where Nᵢ+1 is the number of physical qubits in the cat state. Each cat state CAT[i] corresponding to a target data qubit q[i] is prepared into the cat state

$$\frac{1}{\sqrt{2}} ( \vert + {\text{?}}^{{N}_{i} + 1} + \vert - {\text{?}}^{{N}_{i} + 1} ) .$$

For each cat state to be prepared, the classical computing entity 110 and/or controller 132 may define and/or select a respective cat state preparation circuit. The encoding circuit defined and/or selected for encoding the cat state CAT[i] is configured to encode kᵢ physical qubits into either a control group cat state

$$( i . e . , \frac{1}{\sqrt{2}} ( \vert 0 {\text{?}}^{{N}_{i} + 1} + \vert 1 {\text{?}}^{{N}_{i} + 1} ) ) ,$$

when the data qubit q[i] is a control data qubit, or a target group cat state

$$( i . e . , \frac{1}{\sqrt{2}} ( \vert + {\text{?}}^{{N}_{i} + 1} + \vert - {\text{?}}^{{N}_{i} + 1} ) ) ,$$

when the data qubit q[i] is a target data qubit.

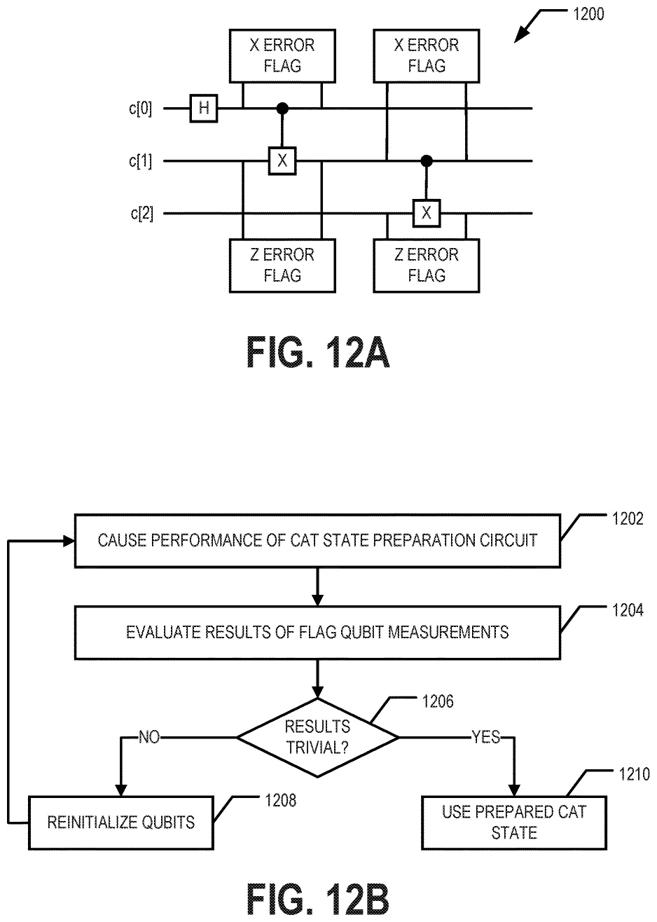

In various embodiments, the cat state preparation circuits are defined to be fault tolerant. For example, the cat state preparation circuits may include flag gadgets configured to cause the cat state preparation circuits to be performed fault tolerantly and/or to enable post-selection of cat states that were prepared fault tolerantly and/or without the occurrence of a detectable error. FIG. 12A illustrates an example fault tolerant cat state preparation circuit 1200 for fault tolerantly preparing the cat state

$$\frac{1}{\sqrt{2}} ( \vert 0 {\text{?}}^{3} + \vert 1 {\text{?}}^{3} ) = \frac{1}{\sqrt{2}} ( \vert 111 \text{?} + \vert 000 \text{?} ) .$$

For example, the classical computing entity 110 may comprise means, such as classical processing elements 1508, classical memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for defining respective cat state preparation circuits corresponding to each data qubit of the logical qubit of the QEC code. For example, the controller 132 may comprise means, such as classical processing elements 1405, classical memory 1410, communications interface 1420, and/or the like, for defining respective cat state preparation circuits corresponding to each data qubit of the logical qubit of the QEC code.

For example, a cat state preparation circuit database (e.g., stored in classical memory 1522, 1524, 1410, and/or the like) may store a plurality of defined cat state preparation circuits (e.g., as respective cat state preparation circuit data objects) that are each associated with a respective number of physical qubits of the cat state and a respective type of cat states (e.g., control group cat state

$$\frac{1}{\sqrt{2}} ( \vert 0 {\text{?}}^{{N}_{i} + 1} + \vert 1 {\text{?}}^{{N}_{i} + 1} ) ) ,$$

target group cat state

$$\frac{1}{\sqrt{2}} ( \vert + {\text{?}}^{{N}_{i} + 1} + \vert - {\text{?}}^{{N}_{i} + 1} ) ) .$$

The cat state preparation circuit database may be queried to identify, determine, and/or select a cat state preparation circuit data object from the plurality of defined cat state preparation circuit data objects that is indexed by and/or associated with a number of physical qubits of the cat state that matches and/or is the same as the code distance of the QEC code and that is indexed by and/or associated with a respective cat state size that matches and/or is the same as the cat state size of the cat state to be prepared. The cat state preparation circuit data objects stored in the cat state preparation circuit database may also be indexed by cat state type (e.g., target group cat states, control group cat states) and the cat state preparation circuit database may be queried to identify, determine, and/or select a from the plurality of defined cat state preparation circuit data objects a cat state preparation circuit data object that is indexed by and/or associated with an appropriate cat state size and cat state type.

At block 1110, the classical computing entity 110 and/or controller 132 defines a cat state-based encoding circuit based on the encoding circuit obtained at block 1104 and using the cat states corresponding to the data qubits of the logical qubit (e.g., having cat state sizes and cat state types corresponding to respective data qubits). In various embodiments, defining a cat state-based encoding circuit includes allocating the first plurality of entangling gates of the encoding circuit to physical qubits of the cat states that correspond to the data states as a second plurality of entangling gates. For example, the cat state-based encoding circuit comprises a second plurality of entangling gates that are defined based at least in part on the first plurality and entangling gates and such that each physical qubit of cat state is party to at most one entangling gate of the second plurality of entangling gates. The first plurality of entangling gates of the encoding circuit are allocated to the physical qubits of the cat states such that each physical qubit of a cat state is party to at most one entangling gate and a physical qubit of each cat state is not party to any entangling gates (this physical qubit is then the data qubit of the encoded logical qubit).

Using the example of the encoding circuit 300, to obtain the cat state-based encoding circuit 1000, the first entangling gate 304A of the encoding circuit 300 is controlled by data qubit q[0] and targeting data qubit q[3] and is assigned to a first physical qubit c0[0] of cat state CAT[0] (corresponding to data qubit q[0]) as the control qubit and a first physical qubit c3[0] of cat state CAT[3] (corresponding to data qubit q[3]) as the target qubit to provide the first entangling gate 1004A of the cat state-based encoding circuit 1000. The second entangling gate 304B of the encoding circuit 300 is controlled by data qubit q[0] and targets data qubit q[4] and is assigned to a second physical qubit c0[1] of cat state CAT[0] (corresponding to data qubit q[0]) as the control qubit and a first physical qubit c4[0] of cat state CAT[4] (corresponding to data qubit q[4]) as the target qubit to provide the second entangling gate 1004B of the cat state-based encoding circuit 1000. The third entangling gate 304C of the encoding circuit 300 is controlled by data qubit q[1] and targets data qubit q[3] and is assigned to a first physical qubit c1[0] of cat state CAT[1] (corresponding to data qubit q[1]) as the control qubit and a second physical qubit c3[1] of cat state CAT[3] (corresponding to data qubit q[3]) as the target qubit to provide the third entangling gate 1004C of the cat state-based encoding circuit 1000. The fourth entangling gate 304D of the encoding circuit 300 is controlled by data qubit q[0] and targets data qubit q[5] and is assigned to a third physical qubit c0[2] of cat state CAT[0] (corresponding to data qubit q[0]) as the control qubit and a first physical qubit c5[0] of cat state CAT[5] (corresponding to data qubit q[5]) as the target qubit to provide the fourth entangling gate 1004D of the cat state-based encoding circuit 1000. The fifth entangling gate 304E of the encoding circuit 300 is controlled by data qubit q[1] and targets data qubit q[4] and is assigned to a second physical qubit c1[1] of cat state CAT[1] (corresponding to data qubit q[1]) as the control qubit and a second physical qubit c4[1] of cat state CAT[4] (corresponding to data qubit q[4]) as the target qubit to provide the fifth entangling gate 1004E of the cat state-based encoding circuit 1000. The sixth entangling gate 304F of the encoding circuit 300 is controlled by data qubit q[2] and targets data qubit q[3] and is assigned to a first physical qubit c2[0] of cat state CAT[2] (corresponding to data qubit q[2]) as the control qubit and a third physical qubit c3[2] of cat state CAT[3] (corresponding to data qubit q[3]) as the target qubit to provide the sixth entangling gate 1004F of the cat state-based encoding circuit 1000. The seventh entangling gate 304G of the encoding circuit 300 is controlled by data qubit q[1] and targets data qubit q[6] and is assigned to a third physical qubit c1[2] of cat state CAT[1] (corresponding to data qubit q[1]) as the control qubit and a first physical qubit c6[0] of cat state CAT[6] (corresponding to data qubit q[6]) as the target qubit to provide the seventh entangling gate 1004G of the cat state-based encoding circuit 1000. The eighth entangling gate 304H of the encoding circuit 300 is controlled by data qubit q[2] and targets data qubit q[5] and is assigned to a second physical qubit c2[1] of cat state CAT[2] (corresponding to data qubit q[2]) as the control qubit and a second physical qubit c5[1] of cat state CAT[5] (corresponding to data qubit q[5]) as the target qubit to provide the eighth entangling gate 1004H of the cat state-based encoding circuit 1000. The ninth entangling gate 304I of the encoding circuit 300 is controlled by data qubit q[2] and targets data qubit q[6] and is assigned to a third physical qubit c2[2] of cat state CAT[2] (corresponding to data qubit q[2]) as the control qubit and a second physical qubit c6[1] of cat state CAT[6] (corresponding to data qubit q[6]) as the target qubit to provide the ninth entangling gate 1004I of the cat state-based encoding circuit 1000.

As a result, each of physical qubits c0[0], c0[1], and c0[2] of cat state CAT[0] are party to one entangling gate 1004 (as control qubits) and physical qubit c0[3] of cat state CAT[0] is not party to any of the entangling gates 1004; each of physical qubits c1[0], c1[1], and c1[2] of cat state CAT[1] are party to one entangling gate 1004 (as control qubits) and physical qubit c1[3] of cat state CAT[1] is not party to any of the entangling gates 1004; each of physical qubits c2[0], c2[1], and c2[2] of cat state CAT[2] are party to one entangling gate 1004 (as control qubits) and physical qubit c2[3] of cat state CAT[2] is not party to any of the entangling gates 1004; each of physical qubits c3[0], c3[1], and c3[2] of cat state CAT[3] are party to one entangling gate 1004 (as target qubits) and physical qubit c3[3] of cat state CAT[3] is not party to any of the entangling gates 1004; each of physical qubits c4[0] and c4[1] of cat state CAT[4] are party to one entangling gate 1004 (as target qubits) and physical qubit c4[2] of cat state CAT[4] is not party to any of the entangling gates 1004; each of physical qubits c5[0] and c5[1] of cat state CAT[5] are party to one entangling gate 1004 (as target qubits) and physical qubit c5[2] of cat state CAT[5] is not party to any of the entangling gates 1004; and each of physical qubits c6[0] and c6[1] of cat state CAT[6] are party to one entangling gate 1004 (as target qubits) and physical qubit c6[2] of cat state CAT[6] is not party to any of the entangling gates 1004.

In certain embodiments, defining the cat state-based encoding circuit further includes assigning qubit measurement operations to be performed on the physical qubits of the cat states that were party to respective entangling gates. For example, each physical qubit of a cat state that was party to a respective entangling gate (as a target qubit or a control qubit) may be assigned a qubit measurement operation. In various embodiments, the physical qubits are assigned qubit measurement operations in a basis (e.g., X-basis or Z-basis) selected based on whether the physical qubit was a target or controlled the entangling gate that the physical qubit was party to. For example, Z errors can propagate from a target qubit to a control qubit during an entangling gate. Thus, the control qubits are assigned qubit measurement operations in the X-basis. X errors can propagate from a control qubit to a target qubit during an entangling gate. Thus, the target qubits are assigned qubit measurement operations in the Z-basis. The physical qubits of the cat states that were not party to any of the entangling gates of the cat state-based encoding circuit are assigned as respective data qubits of the logical qubit.

In some embodiments, such as that illustrated in FIG. 10B, defining the cat state-based encoding circuit may further include assigning a disentangling ladder to one or more of the cat states and then assigning respective qubit measurement operations to the physical qubits other than the data qubits of the logical qubit. In various embodiments, a disentangling ladder is a sequence of disentangling gates (e.g., CNOT gates) that disentangle the physical qubits of a cat state formed of the physical qubits. The final target qubit of a disentangling ladder is the data qubit of the logical qubit corresponding to the cat state that was disentangled by the disentangling ladder. When a disentangling ladder is used, control qubits are assigned qubit measurement operations in the Z-basis and target qubits are assigned qubit measurement operations in the X-basis.

For example, the classical computing entity 110 may comprise means, such as classical processing elements 1508, classical memory 1522, 1524, user input/output interfaces (e.g., display 1516, keypad 1518), communications interfaces (e.g., a radio interface including receiver 1506, transmitter 1504, and antenna 1512 and/or network interface 1520), and/or the like, for defining a cat state-based encoding circuit based on the encoding circuit obtained at block 1104 and using the cat states corresponding to the data qubits of the logical qubit (e.g., having cat state sizes and cat state types corresponding to respective data qubits). For example, the controller 132 may comprise means, such as classical processing elements 1405, classical memory 1410, communications interface 1420, and/or the like, for defining a cat state-based encoding circuit based on the encoding circuit obtained at block 1104 and using the cat states corresponding to the data qubits of the logical qubit (e.g., having cat state sizes and cat state types corresponding to respective data qubits).

At block 1112, the classical computing entity 110 and/or the controller 132 may cause the preparation of the cat states corresponding to each of the data qubits of the logical qubit. For example, the classical computing entity 110 and/or the controller 132 may cause the quantum computer 130 to perform the cat state preparation circuits defined and/or selected at block 1108.

For example, the classical computing entity 110 may provide (e.g., transmit) the cat state preparation circuits for receipt by a quantum computer 130 (e.g., the controller 132 of the quantum computer) for execution thereof. For example, classical computing entity 110 may provide the cat state preparation circuits such that the cat state preparation circuits are configured for receipt by a quantum computer 130 (e.g., the controller 132 of the quantum computer 130). Upon and/or responsive to receipt of the cat state preparation circuits, the quantum computer 130 may execute the cat state preparation circuits to (fault-tolerantly) prepare respective cat states corresponding to the data qubits of the logical qubit and/or store the cat state preparation circuits in memory for performance and/or execution at a later time.

In another example, responsive to defining and/or selecting the cat state preparation circuits, the controller 132 may control operation of the qubit manipulation elements 136 and/or sensors 138 to cause execution of the cat state preparation circuits such that respective cat states are prepared (in a fault-tolerant manner). In some embodiments, the controller 132 may store the cat state preparation circuits in memory (e.g., classical memory 1410) for execution at a later time (e.g., possibly in response to receiving a request from the classical computing entity 110 for performing a quantum circuit).

For example, the classical computing entity 110 may comprise means, such as classical processing elements 1508, classical memory 1522, 1524, communications interfaces (e.g., a radio interface including receiver 1506, transmitter 1504, and antenna 1512 and/or network interface 1520), and/or the like, for causing a quantum computer to execute the cat state preparation circuits. For example, the controller 132 may comprise means, such as classical processing elements 1405, classical memory 1410, driver controller elements 1415, communication interface 1420, and/or the like, for causing the quantum computer 130 to execute the cat state preparation circuits.

FIG. 12A illustrates an example cat state preparation circuit configured for fault tolerantly preparing a cat state with a cat state size of three (e.g., including three physical qubits) into a cat state of the control group cat states type

$$( e . g . , \frac{1}{\sqrt{2}} ( \vert 0 {\text{?}}^{3} + \vert 1 {\text{?}}^{3} ) = \frac{1}{\sqrt{2}} ( \vert 111 \text{?} + \vert 000 \text{?} ) ) .$$

The example cat state preparation circuit 1200 includes a Hadamard gate performed on a first physical qubit c[0] followed by an entangling gate that entangles the first physical qubit c[0] with a second physical qubit c[1] and another entangling gate that entangles the second physical qubit c[1] with the third physical qubit c[2]. X-error flag gadgets and Z-error flag gadgets of the cat state preparation circuit 1200 are configured to detect occurrence of errors during performance of the cat state preparation circuit 1200. As should be understood, various cat states may be prepared using various cat state preparation circuits.

FIG. 12B provides a flowchart illustrating various processes and/or procedures that may be performed by a classical computing entity 110 and/or a controller 132 of a quantum computer 130 to cause fault tolerant preparation of a cat state. Starting at block 1202, the classical computing entity 110 and/or the controller 132 causes the performance of the cat state preparation circuit.

For example, the controller 132 comprises means, such as classical processing elements 1405, classical memory 1410, driver controller elements 1415, and/or the like, for controlling operation of qubit manipulation elements 136 to cause the qubit manipulation elements 136 to perform a plurality of single qubit gates and/or entangling gates (e.g., two-qubit gates) on a plurality of physical qubits to entangle the plurality of physical qubits into a cat state. The plurality of physical qubits are a subset of the plurality of physical qubits 134. The plurality of entangling gates are performed in accordance with the respective cat state preparation.

At block 1204, the controller 132 may evaluate the results of one or more flag qubit measurements. For example, the controller 132 comprises means, such as classical processing elements 1405, classical memory 1410, driver controller elements 1415, A/D converters 1425, and/or the like, for controlling operation of qubit manipulation elements 136 and/or sensors 138 to cause evaluation of the results of flag qubit measurements. For example, the cat state preparation circuit may include one or more flag gadgets and performance of the cat state preparation circuit may include performing qubit measurement operations on one or more flag qubits. The results of the flag qubit measurements may be evaluated to determine respective flag values corresponding to each of the flag qubits.

At block 1206, the controller 132 performs a post-selection operation based on the results of the flag qubit measurements. For example, the controller 132 comprises means, such as classical processing elements 1405, classical memory 1410, and/or the like, for determining whether the results of the flag qubit measurements are trivial (e.g., all of the flag qubits are determined to have an expected value) or non-trivial (e.g., at least one of the flag qubits is determined to have a value other than the expected value). For example, the controller 132 may compare the results of each qubit measurement operation to an expected value to determine whether each flag qubit is determined to have a value that is equal to and/or matches an expected value.

Responsive to determining, at block 1206, that at least one of the results of the flag qubit measurements indicates a corresponding flag qubit has a value that is different from expected value (i.e., the results of the qubit measurement operations are not trivial), the process continues to block 1208. At block 1208, the controller 132 controls operation of the qubit manipulation elements 136 to cause the physical qubits of the cat state to be reinitialized into individual physical qubit |0> states and the process returns to block 1202. For example, the controller 132 comprises means, such as classical processing elements 1405, classical memory 1410, driver controller elements 1415, A/D converters 1425, and/or the like, for reinitializing the physical qubits of the cat state and returning to block 1206 to re-perform the cat state preparation circuit on the reinitialized physical qubits.

Responsive to determining, at block 1206, that all of the results of the flag qubit measurements indicate that the corresponding flag qubits have respective a values that are equal to and/or match an expected value (i.e., the results of the qubit measurement operations are trivial), the process continues to block 1210. At block 1210, the controller 132 controls operation of the qubit manipulation elements 136 to use the prepared cat state to perform one or more quantum computations. For example, the controller 132 may control operation of the qubit manipulation elements 136 to cause the prepared cat state to be used in the preparation of a logical qubit (e.g., via performance of a cat state-based encoding circuit). For example, the controller 132 comprises means, such as classical processing elements 1405, classical memory 1410, driver controller elements 1415, A/D converters 1425, and/or the like, for using the prepared cat state for performing one or more quantum computations.

Returning to FIG. 11, at block 1114, the classical computing entity 110 and/or controller 132 causes preparation and/or encoding of the logical qubit of the QEC code using the cat state-based encoding circuit. For example, the classical computing entity 110 and/or the controller 132 may cause the quantum computer 130 to perform the cat state-based encoding circuit defined at block 1110.

For example, the classical computing entity 110 may provide (e.g., transmit) the cat state-based encoding circuit for receipt by a quantum computer 130 (e.g., the controller 132 of the quantum computer) for execution thereof. For example, classical computing entity 110 may provide the cat state-based encoding circuit such that the cat state-based encoding circuit is configured for receipt by a quantum computer 130 (e.g., the controller 132 of the quantum computer 130). Upon and/or responsive to receipt of the cat state-based encoding circuit, the quantum computer 130 may execute the cat state-based encoding circuit to (fault-tolerantly) prepare a logical qubit and/or store the cat state-based encoding circuit in memory for performance and/or execution at a later time.

In another example, responsive to defining the cat state-based encoding circuit and/or fault tolerantly preparing the cat states corresponding to the data qubits of the logical qubit, the controller 132 may control operation of the qubit manipulation elements 136 and/or sensors 138 to cause execution of the cat state-based encoding circuit such that a logical qubit is prepared (in a fault-tolerant manner). In some embodiments, the controller 132 may store the cat state-based encoding circuit in memory (e.g., classical memory 1410) for execution at a later time (e.g., possibly in response to receiving a request from the classical computing entity 110 for performing a quantum circuit).

For example, the classical computing entity 110 may comprise means, such as classical processing elements 1508, classical memory 1522, 1524, communications interfaces (e.g., a radio interface including receiver 1506, transmitter 1504, and antenna 1512 and/or network interface 1520), and/or the like, for causing a quantum computer to execute the cat state-based encoding circuit. For example, the controller 132 may comprise means, such as classical processing elements 1405, classical memory 1410, driver controller elements 1415, communication interface 1420, and/or the like, for causing the quantum computer 130 to execute the cat state-based encoding circuit.

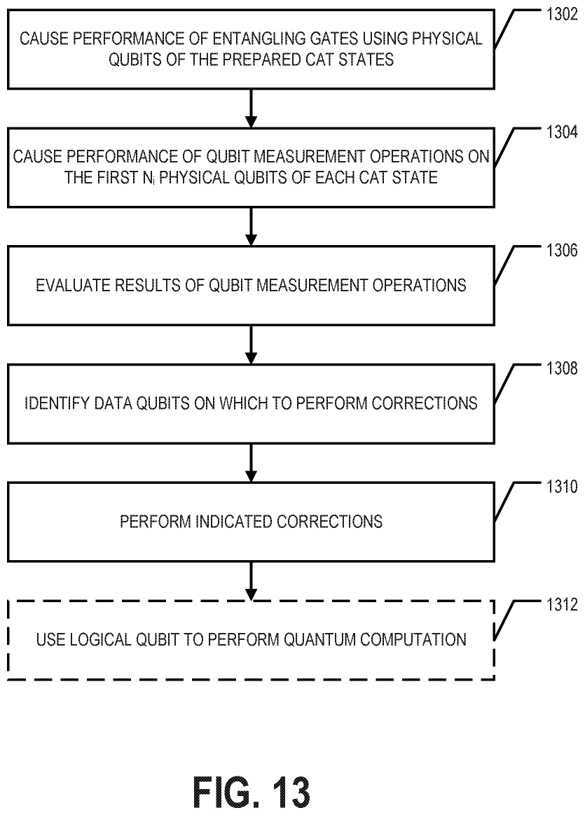

FIG. 13 provides a flowchart illustrating various processes and/or procedures that may be performed by a controller 132, for example, to cause the encoding of a logical qubit of a QEC code using a cat state-based encoding circuit. Starting at block 1302, the controller 132 causes performance of the second plurality of entangling gates of the cat state-based encoding circuit on respective physical qubits of cat states corresponding to data qubits of the logical qubit to encode a logical qubit of the QEC code. The second plurality of entangling gates are performed in accordance with a cat state-based entangling circuit. For example, each physical qubit of each cat state is party to at most one entangling gate of the second plurality of entangling gates. In various embodiments, the second plurality of entangling gates are performed as a depth one action. For example, each entangling gate of the second plurality of entangling gates may be performed in a single layer or single time step of quantum operations of the quantum computer 130. For example, each of the second plurality of entailing gates may be performed in parallel, at least partially overlapping in time, and/or without requiring re-arranging of the physical qubits between respective entangling gates of the second plurality of entangling gates.

For example, the controller 132 comprises means, such as classical processing elements 1405, classical memory 1410, driver controller elements 1415, and/or the like, for controlling operation of qubit manipulation elements 136 to cause the qubit manipulation elements 136 to perform the second plurality of entangling gates on the physical qubits of the prepared cat states logically organize and/or entangle the data qubits into the logical qubit. The plurality of data qubits are a subset of the plurality of physical qubits 134 (e.g., one physical qubit from each cat state). The second plurality of entangling gates are performed in accordance with the cat state-based encoding circuit. The second plurality of entangling gates are performed such that each entangling gate of the plurality of entangling gates is controlled by a control physical qubit and targets a target physical qubit. Each cat state includes only control physical qubits or only target physical qubits. In other words, none of the cat states include a combination of control physical qubits and target physical qubits. A cat state that includes control physical qubits corresponds to a data qubit of the logical qubit that is in the control group and a cat state that includes target physical qubits corresponds to a data qubit of the logical qubit that is in the target group. The control group and the target group are non-overlapping.

At block 1304, the controller 132 controls operation of the qubit manipulation elements 136 and sensors 138 to cause performance of qubit measurement operations on Nᵢ physical qubits of each cat state CAT[i]. For example, each cat state CAT[i] includes Nᵢ+1 physical qubits. Nᵢ physical qubits of the cat state CAT[i] were party to an entangling gate of the second plurality of entangling gates and qubit measurement operations are performed on those Nᵢ physical qubits that were party to an entangling gate of the second plurality of entangling gates. For example, the controller 132 comprises means, such as classical processing elements 1405, classical memory 1410, driver controller elements 1415, and/or the like, for controlling operation of the qubit manipulation elements 136 and sensors 138 to cause performance of qubit measurement operations on the Nᵢ physical qubits of each cat state were party to an entangling gate of the second plurality of entangling gates.

At block 1306, the controller 132 evaluates the results of the qubit measurements. For example, the qubit measurement operations performed on the Nᵢ physical qubits of a cat state may indicate a parity of the cat state. For example, the controller 132 may comprise means, such as classical processing elements 1405, classical memory 1410, and/or the like, for evaluating the results of the qubit measurement operations to, for example, determine a parity of each cat state.

At block 1308, the controller 132 determines, for each data qubit, whether results of the qubit measurement operations on the physical qubits of the corresponding cat state indicate that a correction should be performed on the data qubit. For example, the controller 132 may compare a determined parity of a cat state to an expected parity of a cat state to determine whether a correction should be performed on the corresponding data qubit. For example, responsive to determining that the parity of the cat state is equal to or matches the expected parity, the controller 132 may determine to not perform any corrections on the corresponding data qubit (e.g., the data qubit corresponding to the cat state) and responsive to determining that the parity of the cat state is different from or does not match the expected parity, the controller 132 may determine to perform a correction on the corresponding data qubit. For example, the controller 132 may comprise means, such as classical processing elements 1405, classical memory 1410, and/or the like, for determining whether a correction should be performed on one or more data qubits. For example, the controller 132 may identify any data qubits for which the results of the qubit measurement operations performed on the physical qubits of the corresponding cat state indicate a correction should be performed on the data qubit.

At block 1310, the controller 132 controls operation of the qubit manipulation elements to cause performance of respective corrections on any of the data qubits of the logical qubit identified for performance of a correction. For example, the controller may perform a respective correction on each data qubit identified at block 1308. In various embodiments, the correction is a bit flip operation. For example, the controller 132 comprises means, such as classical processing elements 1405, classical memory 1410, driver controller elements 1415, and/or the like, for controlling operation of the qubit manipulation elements 136 and sensors 138 to cause performance of respective corrections on any data qubits identified for having a correction performed thereon.

At block 1312, the logical qubit has been fault tolerantly prepared and/or encoded any may be used to perform a quantum computation. For example, the controller 132 may control operation of the qubit manipulation elements 136 and/or sensors 138 to cause the quantum computer 130 to perform a quantum computation using the prepared logical qubit. For example, the controller 132 comprises means, such as classical processing elements 1405, classical memory 1410, driver controller elements 1415, and/or the like, for controlling operation of the qubit manipulation elements 136 and sensors 138 to cause performance of a quantum computation using the logical qubit.

### Technical Advantages

Complex quantum computations demand levels of precision that are not available in conventional quantum computers due to imperfect control and noise in gate operations between data qubits, for example. Proposed schemes for quantum error correction (QEC) include the organization of data qubits into logical qubits in accordance with a selected QEC code. Each QEC code is associated with and/or labeled by a code distance that indicates the number of errors or error weight to which the QEC code is robust. For the use of logical qubits to provide fault-tolerant quantum computing, the logical qubits must be prepared in a fault-tolerant manner. However, the preparation of logical qubits is not optimized and may often include too many errors to provide a fault tolerant logical qubit preparation. Therefore, technical problems exist regarding preparation of logical qubits in a fault-tolerant manner.

Various embodiments provide technical solutions to these technical problems. For example, various embodiments provide methods, systems, apparatus, computer program products, and/or the like for preparing logical qubits in accordance with a CSS QEC code. For example, in various embodiments, a logical qubit includes a plurality of data qubits that are entangled in accordance with a particular (CSS) QEC code. The data qubits are physical qubits of the quantum computer/processor. The plurality of data qubits of a logical qubit are divided into a control group and a target group. During the logical qubit preparation, the qubits of the control group are used as the control qubits in performing CNOT gates on respective qubits of the target group. In other words, the logical qubit is prepared as a bipartite graph state. For example, the encoding circuit for preparing the logical qubit includes a plurality of CNOT gates that each include a respective control qubit from the control group of data qubits and a respective target qubit from the target group of data qubits. This provides for improved efficiency of the preparation of the logical qubit. This enables a more efficient preparation of the logical qubits and limits the errors that can occur and/or be propagated through the preparation of the logical qubit.

In particular, as a result of the structure of the encoding circuit, the only errors that may be propagated to qubits of the control group are X errors and the only errors that may be propagated to qubits of the target group are Z errors. Because the X and Z errors can each only propagate in one direction, they can be detected at the origin using flag gadgets, providing additional efficiency in the logical qubit preparation.

Each flag gadget includes entangling one or more ancilla/flag qubits with a data qubit of the logical qubit at a first respective point during preparation of the logical qubit (e.g., via a CNOT gate controlled by the physical qubit), un-entangling the ancilla/flag qubit(s) with the physical qubit at a second respective point, and measuring the flag/ancilla qubit(s). The first respective points, second respective points, and the number of ancilla/flag qubits are determined such that any errors of a weight greater than the tolerance of the code are identified. Post-selection based on the measurements of the ancilla/flag qubits may be used to ensure a fault-tolerant preparation of the logical qubit.

Moreover, as the structure of the flag gadget applied to a data qubit is determined based only on the distance of the QEC code and the number of CNOT gates applied to the data qubit in the encoding circuit, flag gadgets for a broad range of (CSS) QEC codes may be predetermined and implemented in a modular manner when preparing the logical qubit preparation circuit.

According to various embodiments, to optimize a flag gadget, it may be determined if a flag gadget having p ancilla/flag qubits that is capable of identifying errors of an appropriate weight for the distance of the code exists. If such a flag gadget exists, p is an upper bound on the minimum number of ancilla/flag qubits required for the flag gadget. It may then be determined whether a flag gadget having p−1 ancilla/flag qubits and that is able to identify errors of an appropriate weight for the code exists. This process may be continued until a solution with a smaller number of ancilla/flag qubits cannot be identified such that a minimal upper bound on the minimum number of ancilla/flag qubits for a particular flag gadget (corresponding to a code distance and number of CNOT gates) is determined.

Therefore, various embodiments provide an efficient fault-tolerant preparation of logical qubits that may include the inclusion of modular, predetermined/generated flag gadgets that can be inserted into an encoding circuit to generate an efficient and fault-tolerant logical qubit preparation circuit. Thus, various embodiments provide technical improvements to the fields of quantum computing, fault-tolerant quantum computing, fault-tolerant logical qubit preparation, and/or the like.

### Example Controller

In various embodiments, quantum computing system 100 comprises a quantum computer 130. The quantum computer may include one or more quantum processing units (QPUs) that each include respective physical qubits 134, qubit manipulation elements 136, and sensors 138. The quantum computer 130 is configured to perform various quantum computations and/or calculations via execution of one or more quantum circuits and/or algorithms. In various embodiments, the controller 132 is configured to control operation of one or more components of the quantum computer 130 (e.g., qubit manipulation elements 136, sensors 138), receive sensor signals indicating measurements captured by sensors 138, and/or communicate with a classical computing entity 110.

As shown in FIG. 14, in various embodiments, the controller 132 may comprise various controller elements including processing elements 1405, memory 1410, driver controller elements 1415, a communication interface 1420, analog-digital converter elements 1425, and/or the like. For example, the processing elements 1405 may comprise one or more (classical and/or semiconductive-based) processing devices such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the processing element 1405 of the controller 132 comprises a clock and/or is in communication with a clock.

For example, the memory 1410 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1410 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 1410 (e.g., by a processing element 1405) causes the controller 132 to perform one or more steps, operations, processes, procedures and/or the like described herein for controlling operation of one or more qubit manipulation elements 136, processing sensor signals indicating measurements captured by sensors 138, and/or communicating with a classical computing entity 110 of the quantum computing system 100.

In various embodiments, the driver controller elements 1415 may include one or more drivers and/or controller elements each configured to control one or more drivers. In various embodiments, the driver controller elements 1415 may comprise drivers and/or driver controllers. For example, the driver controllers may be configured to cause one or more corresponding drivers to be operated in accordance with executable instructions, commands, and/or the like scheduled and executed by the controller 132 (e.g., by the processing element 1405). In various embodiments, the driver controller elements 1415 may enable the controller 132 to operate various ones of the qubit manipulation elements 136 and/or sensors 138. In various embodiments, the drivers may comprise laser drivers configured to operate one or lasers; drivers for controlling operation of one or more voltage/current sources to cause generation and providing of one or more voltage and/or current signals; and/or various other drivers configured to control operation of respective qubit manipulation elements 136 of the quantum computer 130.

In various embodiments, the controller 132 comprises means for communicating and/or receiving signals from one or more sensors (e.g., photodetectors, voltage/current sensors, temperature sensors, pressure sensors, and/or other sensors). For example, the controller 132 may comprise one or more analog-digital converter elements 1425 configured to receive signals from one or more sensors.

In various embodiments, the controller 132 comprises a communication interface 1420 for interfacing and/or communicating with a classical computing entity 110 of the quantum computing system 100. For example, the controller 132 may comprise a communication interface 1420 for receiving quantum circuits, executable instructions, command sets, and/or the like from the classical computing entity 110 and providing output (e.g., measurement results) received from the quantum computer 130 (e.g., via sensors 138) to the classical computing entity 110. In various embodiments, the classical computing entity 110 and the controller 132 may communicate via a direct wired and/or wireless connection and/or via one or more wired and/or wireless networks 120.

### Example Classical Computing Entity

FIG. 15 provides an illustrative schematic representative of an example classical computing entity 110 that can be used in conjunction with embodiments of the present invention. In various embodiments, a classical computing entity 110 is configured to interface with a quantum computer 130. For example, the classical computing entity 110 is configured to interface with a quantum computer 130 so as to enable the efficient and accurate modeling of various systems using the quantum computer 130. For example, the classical computing entity 110 may be configured to communicate with the quantum computer 130 allow a user (e.g., a human user or a program operating on the classical computing entity 110) to provide input to the quantum computer 130 and receive, display, analyze, and/or the like output (e.g., measurement results) from the quantum computer 130. In various embodiments, a classical computing entity 110 may be a computer (e.g., desktop computer, laptop, tablet, smartphone, and/or the like), a server, a Cloud-based computing resource, and/or the like.

As shown in FIG. 15, a classical computing entity 110 can include an antenna 1512, a transmitter 1504 (e.g., radio), a receiver 1506 (e.g., radio), and a processing element 1508 that provides signals to and receives signals from the transmitter 1504 and receiver 1506, respectively. The signals provided to and received from the transmitter 1504 and the receiver 1506, respectively, may include signaling information/data in accordance with an air interface standard of applicable wireless systems to communicate with various entities, such as a controller 132, other classical computing entities 110, and/or the like. In this regard, the classical computing entity 110 may be capable of operating with one or more air interface standards, communication protocols, modulation types, and access types.

For example, the classical computing entity 110 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the classical computing entity 110 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The classical computing entity 110 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the classical computing entity 110 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The classical computing entity 110 can also download changes, add-ons, and updates, for instance, to its firmware, software (e.g., including executable instructions, applications, program modules), and operating system.

In various embodiments, the classical computing entity 110 may comprise a network interface 1520 for interfacing and/or communicating with the controller 132, for example. For example, the classical computing entity 110 may comprise a network interface 1520 for providing quantum circuits, executable instructions, command sets, and/or the like for receipt by the controller 132 and/or receiving output (e.g., measurement results) provided by the quantum computer 130. In various embodiments, the classical computing entity 110 and the controller 132 may communicate via a direct wired and/or wireless connection and/or via one or more wired and/or wireless networks 120.

In various embodiments, the processing elements 1508 may comprise one or more processing devices such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, graphics processing units (GPUs), central processing units (CPUs), other processing devices and/or circuitry, and/or the like. The term circuitry may refer to an entirely hardware embodiment or a combination of hardware and computer program products.

The classical computing entity 110 may also comprise a user interface device comprising one or more user input/output interfaces (e.g., a display 1516 and/or speaker/speaker driver coupled to a processing element 1508 and a touch screen, keyboard, mouse, and/or microphone coupled to a processing element 1508). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1518 (hard or soft), a touch display, mouse, voice/speech or motion interfaces, scanners, readers, or other input device. In embodiments including a keypad 1518, the keypad 1518 can include (or cause display of) the conventional numeric (0-9) and related keys (#, *), and other keys used for operating the classical computing entity 110 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the classical computing entity 110 can collect information/data, user interaction/input, and/or the like.

The classical computing entity 110 can also include volatile storage or memory 1522 and/or non-volatile storage or memory 1524, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the classical computing entity 110.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for fault-tolerantly preparing a logical qubit of a QEC code, the method comprising:
causing, in accordance with an encoding circuit, performance of a plurality of entangling gates on respective pairs of a plurality of physical qubits, wherein each entangling gate of the plurality of entangling gates is controlled by a control physical qubit and targets a target physical qubit, wherein the control physical qubit is a member of a control group corresponding to at least one control data qubit of a plurality of data qubits of the logical qubit and the target physical qubit is a member of a target group corresponding to one or more target data qubits of the plurality of data qubits, wherein the control group and the target group are non-overlapping.

2. The method of claim 1, wherein each control physical qubit is either a control data qubit of the logical qubit or entangled with a control data qubit of the logical qubit and each target physical qubit is either a target data qubit of the logical qubit or entangled with a target data qubit of the logical qubit.

3. The method of claim 1, wherein each control physical qubit of the control group is used to control at least one entangling gate of the plurality of entangling gates and each target physical qubit of the target group is targeted by at least one entangling gate of the plurality of entangling gates.

4. The method of claim 1, wherein none of one or more control physical qubits of the control group are used as a target of an entangling gate of the plurality of entangling gates and none of one or more target physical qubits of the target group are used as a control of an entangling gate of the plurality of entangling gates.

5. The method of claim 1, wherein each data qubit of the plurality of data qubits is a physical qubit and each entangling gate of the plurality of entangling gates is a controlled gate.

6. The method of claim 1, further comprising for a first data qubit of the plurality of data qubits, executing a first flag gadget.

7. The method of claim 6, wherein the first flag gadget corresponds to a code distance of the QEC code and a number of entangling gates of the plurality of entangling gates to which the first physical qubit is a party.

8. The method of claim 7, wherein the first flag gadget is inserted into the encoding circuit.

9. The method of claim 7, wherein the first flag gadget is selected from a plurality of defined flag gadgets based on the code distance of the QEC code and the number of entangling gates to which the first physical qubit is a party.

10. The method of claim 6, wherein executing the first flag gadget comprises causing entanglement of one or more flag qubits with the first physical qubit at respective entanglement points during the performance of the plurality of entangling gates of the encoding circuit, causing disentanglement of the one or more flag qubits from the first physical qubit at respective disentanglement points during or after the performance of the plurality of entanglement gates of the encoding circuit, and causing performance of measurements of the one or more flag qubits.

11. The method of claim 10, further comprising performing a post-selection operation on the logical qubit based on results of the measurements of the one or more flag qubits.

12. The method of claim 10, wherein the respective entanglement points for each of the one or more flag qubits and the respective disentanglement points for each of the one or more flag qubits are configured such that the flag gadget is able to detect any errors that can propagate to a higher weight than an original weight of the error.

13. The method of claim 10, wherein entanglement of the first physical qubit and a flag qubit of the one or more flag qubits is enacted by a controlled entangling gate using the first physical qubit to control the controlled entangling gate and using the flag qubit as a target of the controlled entangling gate and disentanglement of the first physical qubit and the flag qubit is enacted by a controlled disentangling gate using the first physical qubit to control the controlled disentangling gate and using the flag qubit as the target of the controlled disentangling gate.

14. The method of claim 1, further comprising:
causing performance of a plurality of flag gadgets, wherein each flag gadget corresponds to a respective data qubit of the plurality of data qubits; and
performing a post-selection operation on the logical qubit based on results of performing the plurality of flag gadgets.

15. The method of claim 1, wherein the logical qubit is prepared as a bipartite graph state.

16. The method of claim 1, further comprising:
prior to performing the plurality of entangling gates, preparing a plurality of cat states, each cat state of the plurality of cat states (a) comprising a respective plurality of physical qubits that are entangled with one another and (b) corresponds to a data qubit of the plurality of data qubits of the logical qubit, wherein each entangling gate of the plurality of entangling gates is performed on a pair of physical qubits of different cat states.

17. The method of claim 16, wherein a selected physical qubit of each cat state is the data qubit to which the cat state corresponds.

18. The method of claim 16, further comprising:
after performance of the plurality of entangling gates, performing a qubit measurement operations on at least one of the respective plurality of physical qubits of the cat state;
determining whether to perform a correction on the data qubit corresponding to the cat state based at least in part on a result of performing the qubit measurement operation on the at least one of the respective plurality of physical qubits of the cat state; and
responsive to determining to perform the correction on the data qubit, causing performance of the correction on the data qubit.

19. A system comprising:
a plurality of physical qubits;
qubit manipulation elements; and
a controller configured to control operation of the qubit manipulation elements to cause the system to perform at least:
performing, in accordance with an encoding circuit, a plurality of entangling gates on respective pairs of a plurality of physical qubits, wherein each entangling gate of the plurality of entangling gates is controlled by a control physical qubit and targets a target physical qubit, wherein the control physical qubit is a member of a control group corresponding to at least one control data qubit of a plurality of data qubits of the logical qubit and the target physical qubit is a member of a target group corresponding to one or more target data qubits of the plurality of data qubits, wherein the control group and the target group are non-overlapping.

20. A quantum system controller comprising at least one classical processing element and a non-transitory classical memory storing computer-executable instructions, the classical memory and computer-executable instructions configured to, when executed by the at least one classical processing element, cause the controller to perform at least:
causing, in accordance with an encoding circuit, performance of a plurality of entangling gates on respective pairs of a plurality of physical qubits, wherein each entangling gate of the plurality of entangling gates is controlled by a control physical qubit and targets a target physical qubit, wherein the control physical qubit is a member of a control group corresponding to at least one control data qubit of a plurality of data qubits of the logical qubit and the target physical qubit is a member of a target group corresponding to one or more target data qubits of the plurality of data qubits, wherein the control group and the target group are non-overlapping.

21-46. (canceled)
